(19) United States
(12) Patent Application Publication
(10) Pub. No.: US 2004/0086117 A1
(43) Pub. Date: May 6, 2004

(54) Methods for improving unpredictability of output of pseudo-random number generators

(76) Inventors: Mette Vesterager Petersen, Frederiksberg (DK); Hans Martin Boesgaard Sorensen, Lyngby (DK)

Correspondence Address: HARNESS, DICKEY & PIERCE, P.L.C., P.O. BOX 8910, RESTON, VA, 20195, US

(21) Appl. No.: 10/455,297

(22) Filed: Jun. 6, 2003

Related U.S. Application Data
(60) Provisional application No. 60/385,909, filed on Jun. 6, 2002.
(60) Provisional application No. 60/446,562, filed on Feb. 12, 2003.

(51) Int. Cl. H04L 9/00

(52) U.S. Cl. 380/44

(57) ABSTRACT

A method for performing computations in a mathematical system which exhibits a positive Lyapunov exponent, or exhibits chaotic behavior, comprises varying a parameter of the system. When employed in cryptography, such as, e.g., in a pseudo-random number generator of a stream-cipher algorithm, in a block-cipher system or a HASH/MAC system, unpredictability may be improved. In a similar system, a computational method comprises multiplying two numbers and manipulating at least one of the most significant bits of the number resulting from the multiplication to produce an output. A number derived from a division of two numbers may be used for deriving an output. In a system for generating a sequence of numbers, an array of counters is updated at each computational step, whereby a carry value is added to each counter. Fixed-point arithmetic may be employed. A method of determining an identification value and for concurrently encrypting and/or decrypting a set of data is disclosed.

### TECHNICAL FIELD

The present invention relates to aspects of improving unpredictability of pseudo-random numbers which originate from numerical computations in mathematical systems comprising at least one function, in particular a non-linear function. The mathematical system may be a non-linear system of differential equations which exhibits chaotic behavior. The invention is useful in encryption and decryption in, e.g., electronic devices.

### BACKGROUND OF THE INVENTION

Cryptography is a generally used term covering science and technology concerned with transforming data, such transforming of data being performed with the aim of allowing for storing and transmitting of the data while preventing unauthorized access to the data. By means of cryptography, the data are made non-comprehensible for any other person but the intended recipient or recipients of the data. Accordingly, cryptography plays an increasingly more important role in the protection of intellectual property, including copyright protection, as the technological advancements require safe transmission and storage of huge amounts of data.

In an encryption and decryption algorithm, the specific transformation of data is dependent on an input to the algorithm, a so-called key. In case the sender and the recipient of the data have an appropriate set of keys, the sender and the recipient are able to correctly encrypt and decrypt the data while any third person who may gain access to the encrypted data is not able to view a properly decrypted version of the encrypted data, as she or he is not in possession of an appropriate key.

Usually, a set of data to be encrypted is referred to as “plaintext” or “original data”, whereas the encrypted version of the set of data is referred to as “ciphertext” or “encrypted data”.

Two types of symmetric cryptographic algorithms are the so-called “block cipher” and the so-called “stream cipher”. Both types of algorithms use symmetric keys, i.e. the keys used for encryption and decryption are equal or trivially related. A block cipher is a cryptographic algorithm which splits an original set of data into a plurality of blocks of a given size, e.g. 64 bits per block. Mathematical and logical operations are performed on each block, whereby the original amount of data is usually transformed into blocks of pseudo-random data. In case decryption is initiated with the correct decryption key, the original data can be re-called by reversing the mathematical and logical operations used for encryption.

In a (synchronous) stream cipher, a pseudo-random number generator generates, based on a key, a sequence of pseudo-random numbers, the sequence being referred to as a keystream. The keystream is mixed, by arithmetic and/or logical operations, with a plurality of sub-sets of the original set of data, the sum of sub-sets of data defining the original data to be encrypted. The result of the mixing is the encrypted data. The set of encrypted data may be decrypted by repeating the procedure in such a way that the pseudo-random sequence is extracted from the encrypted data, so as to arrive at the original, decrypted data.

The plaintext is often mixed with the keystream by use of a logical operator, most often by the so-called XOR operator, also referred to as the “exclusive or” operator, which is symbolized by the ⊕ symbol. XOR generates a one-bit result from two one-bit arguments. All possible combinations are:

0⊕0=0

0⊕1=1

1⊕0=1

1⊕1=0

Utilization of the XOR operator on a plaintext and a pseudo-random keystream yields a ciphertext. During decryption, an identical keystream is generated, and the XOR operator is now utilized on the keystream and the ciphertext, resulting in the original plaintext. The identical keystream can only be generated by using the key on which the keystream for encryption was initially based.

Further, so-called public key systems have been developed, such systems being characterized by a pair of asymmetric keys, i.e. a public key and a private key, the two keys being different. In such systems, the public key is usually used for encryption, and the private key is usually used for decryption. The private and the public key correspond to each other in a certain manner. The key which is used for encryption cannot be used for decryption, and vice versa. Thus, the public key may be published without violating safety in respect of accessibility of the original data. Accordingly, when transmitting encrypted data via a computer communications network, the recipient of the data first generates a set of keys, including a public and a private key. The public key, for example, is then provided to the sender of the data, whereas the private key is stored at a secure location. The sender of the data utilizes the public key for encrypting the original data, and the encrypted data are then transferred to the recipient. When the recipient receives the encrypted data, the private key, which corresponds to the public key previously utilized for encryption, is provided to the decryption system which processes the encrypted data so as to arrive at the original decrypted data. Public key systems are primarily used for transmitting keys which are utilized in, e.g., block or stream ciphers, which in turn perform encryption and decryption of the data.

The methods of the present invention are applicable to cryptographic methods and cryptographic systems, in particular but not exclusively to stream cipher algorithms, block cipher algorithms, Hash functions, and MAC (Message Authentication Code) functions. Such methods, functions and algorithms may include pseudo-random number generators which are capable of generating pseudo-random numbers in a reproducible way, i.e. In a way that results in the same numbers being generated in two different cycles when the same key is used as an input for the pseudo-random number generator in the two cycles.

In pseudo-random number generators, numerical solutions of chaotic systems, i.e. systems of non-linear differential equations or mappings exhibiting chaotic behavior, have been proposed. The term “chaotic” may in a strict mathematical sense only be used in the context of a continuous system. However, the present text also refers to discrete or finite systems having at least one positive Lyapunov exponent as being “chaotic”.

A chaotic system normally governs at least one state variable X, the numerical solution method of such a system normally comprising performing iteration or integration steps. In a chaotic system, the solution Xₙ at a given instant is dependent on the initial condition X₀ to such an extent that a small deviation in X₀ will result in a huge deviation in the solution Xₙ, the system often being referred to as exhibiting sensitivity on initial conditions. Thus, in order for the pseudo-random number generator, i.e. the algorithm numerically solving the chaotic system, to give a reproducible stream of pseudo-random numbers, the exact initial condition X₀ must be known. Thus, in cryptographic algorithms relying on chaotic systems, the initial condition X₀ used in the numerical solution of the chaotic system is derived from the key entered by a user of the cryptographic system, thereby allowing the same stream of pseudo-random numbers to be generated for e.g. encryption and decryption of data.

Lyapunov exponents measure the rates of divergence or convergence of two neighboring trajectories, i.e. solution curves, and can be used to determine the stability of various types of solutions, i.e. determine whether the solution is for example periodic or chaotic. A Lyapunov exponent provides such a measure from a comparison between a reference orbit and a displaced orbit. Iterates of the initial condition x₀ are denoted the reference orbit, and the displaced orbit is given by iterates of the initial condition x₀+y₀, where y₀ is a vector of infinitely small length denoting the initial displacement. The initial orientation of the initial displacement is given by u₀=y₀/|y₀|. Using this notation, the Lyapunov exponent, h(x₀, y₀), is defined as

$$h ( {x}_{0} , {u}_{0} ) = {lim}_{n \to ∞} \frac{1}{n} ln ( \vert {y}_{n} \vert / \vert {y}_{0} \vert )$$

where yₙ is the deviation of the displaced orbit from the reference orbit, given by the n'th iterate of x₀. For systems whose dimension is larger than one, there is a set or spectrum of Lyapunov exponents, each one characterizing orbital divergence or convergence in a particular direction. Thus, if the system has N degrees of freedom, it will have N Lyapunov exponents which, however, are not necessarily distinct. In all practical situations, a positive Lyapunov exponent indicates chaos. The type of irregular behavior referred to as hyperchaos is characterized by two or more positive Lyapunov exponents. Numerical calculation of Lyapunov exponents may be performed according to the suggested method in T. S. Parker and L. O. Chua: Practical Numerical Algorithms for Chaotic Systems, pp. 73-81 .

Even more irregular systems than hyperchaotic systems exhibit so-called turbulence, which refers to the type of behaviour exhibited by a system having a continuous spectrum of positive Lyapunov exponents. Turbulence may be modeled by partial differential equations, for example the well-known Navier-Stokes equations.

A large number of prior art documents are concerned with solving chaotic systems, in particular to be used in cryptographic algorithms, also including stream cipher algorithms relying on chaotic systems, some of which are briefly mentioned below as a general introduction to the background art.

U.S. Pat. No. 5,007,087 assigned to Loral Aerospace Corp. discloses a method and an apparatus for generating random numbers using chaos. The patent describes solving chaotic systems for generating random number sequences and mentions its possible use in cryptography, in particular in the field of key generation and management. The document mentions that repeatability of the number sequence should be avoided.

U.S. Pat. No. 5,048,086 assigned to Hughes Aircraft Company is related to an encryption system based on chaos theory. The system uses the logistic equation xₙ₊₁=μxₙ(1−xₙ), which is a mapping exhibiting chaos for certain values of μ. In the computations, floating-point operations are used.

PCT Application WO 98/36523 assigned to Apple Computer, Inc. discloses a method of using a chaotic system to generate a public key and an adjustable back door from a private key. The need for establishing rules of precision during computations on a chaotic system is mentioned. The document states, as an example, that a specified floating point or fixed point precision can be identified along with specific standards for round-off.

PCT Application WO 02/47272 assigned to the assignee of the present application discloses various aspects of cryptography, including the use of so-called fixed-point numbers.

PCT application WO 01/50676 assigned to Honeywell Inc. discloses a non-linear cryptographic isolator for converting a so-called vulnerable keystream into a so-called protected keystream. The non-linear filter cryptographic isolator includes a multiplier for performing a multiplication function on the vulnerable keystream to provide a lower partial product array and an upper partial product array, and a simple unbiased operation for combining the lower partial product array and the upper partial product array to provide the protected keystream.

“Numerical Methods and Software” by D. Kahaner, C. Moler and S. Nash (Prentice-Hall International Editions, 1989) contains a general introduction to (pseudo-)random number generation. The book mentions the following criteria for judging the quality of (pseudo-)random number generators:

a) High quality: the generator should pass all the statistical tests and have an extremely long period,

b) Efficiency: execution should be rapid and storage requirements minimal.

c) Repeatability: Specifying the same starting conditions will generate the same sequence. The user should be able to restart the generator at any time, but explicit initialization is not necessary. A slight change in the starting procedure will result in a different random sequence.

d) Machine independence and portability: The algorithm should work on different kinds of computers; in particular, no operation should cause the program to stop. The same sequence of random numbers should be produced on different computers by initializing the generator in exactly the same way.

e) Simplicity: The algorithm should be easy to implement and use. The book further states that no generator can be successful in satisfying all of these criteria.

It is further known to use fixed-point variables in numerical computations, for example in Intel Mandelbrot computations. Intel (cf. MMX™ Technology Application Notes, “Implementing Fractals with MMX™ Technology”, publicly accessible on http://cedar.intel.com/cgi-bin/ids.dll/content/content.jsp?cntKey=Legacy::irtm_MANDEL_{—}10491&cntType=IDS_EDITORIAL&catCode=0 on 6 June 2003) has explained how a Mandelbrot set (the set being derivable from a non-linear system) may be computed in a fast manner using MMX technology (an add-on to Intel's processors which speeds up certain computations). This is done using fixed-point computations.

The Mandelbrot set is computed by means of the below mapping:

zₙ₊₁=zₙ²−μ

Intel utilizes a constant decimal separator position in their computations. A so-called 5.11 is utilized, i.e. a 16 bit number is utilized wherein the decimal separator is placed after the 5'th bit, “5” referring to 5 bits after the decimal separator, “11” referring to 11 bits after the decimal separator.

### SUMMARY OF THE INVENTION

Pseudo-random numbers generators as those used in cryptography should, while allowing for reproducibility of a sequence of pseudo-random numbers, generally be as unpredictable as possible. In other words, an internal state of a mathematical system underlying the generator should contain as little information as possible concerning other internal states of the mathematical system. For example, the information that a particular value “Xᵢ” was contained in state variable “X” at iteration No. i should not in a predictable manner lead to another value “Xⱼ” which was contained in the variable “X” at another iteration, iteration No. j. When an iterative mathematical system is expressed in discrete terms, problems with small periods can arise in the sense that a certain degree of predictability may arise if or when the mathematical system becomes periodic. In a cryptographic system this is a serious problem since it will have the effect that data will be encrypted repeating the same block of pseudo-random data which comprises security.

The present invention provides four aspects, preferred embodiments of which improve security by improving unpredictability:

1. Variation of a parameter of a mathematical system exhibiting a positive Lyapunov exponent (claims 1-17)

2. Manipulation of at least one of the most significant bits of a number resulting from a multiplication operation (claims 18-43 and 55), the “g-function”

3. Combining of the quotient and the remainder of a number resulting from a division operation (claim 44).

4. Updating of counter values by means of a carry value (claims 45-55).

With the additional aim of improving speed in computations, the present invention provides, in a further independent aspect:

5. Concurrent encryption and identification value generation (claims 56-61).

The above aspects of the invention will be discussed in sections 1-5 below. Disclosure and discussions which apply to all aspects of the invention are included in sections A-L below.

1 Variation of a Parameter of a Mathematical System Exhibiting a Positive Lyapunov Exponent

A first aspect of the present invention provides a method for repeatedly performing computations in a mathematical system which exhibits a positive Lyapunov exponent, comprising varying at least one parameter of the mathematical system after a certain number of computations. The parameter, which may, e.g., be a counter, may vary independently of the mathematical system and may cause the mathematical system to produce output periods which are longer than if the parameter would not have been varied, or it may cause the mathematical system to exhibit periodic behaviour with periods which are so long that, in any practical application, the mathematical system will not repeat itself. The parameter may be repeatedly varied throughout computations in the mathematical system.

In connection with a system with a positive Lyapunov exponent, i.e. a system exhibiting so-called chaotic behaviour, there exists the further challenge that rounding-off of floating-point numbers is not necessarily performed consistently on two different processors, in which case—due to the positive Lyapunov exponent—a sequence of pseudo-random numbers generated on a first processor may not be reproducible on a second processor. Usually on a computer, real numbers are represented by floating point type numbers. A floating-point number is defined as a number consisting of a mantissa and an exponent, e.g. 31415·10⁴, where “31415” is the mantissa and “−4” is the exponent. When a computer is performing a calculation on a floating-point variable, it recalculates the exponent to match the result. The name “floating-point” refers to the fact that the decimal separator is moving at calculations, caused by the varying exponent. However, floating point arithmetic is defined differently on various processor architectures causing different handling of precision and rounding off. The present inventors have realised that, instead of floating-point numbers, fixed-point numbers can be used. Thus, in embodiments of the methods of the invention, computations such as iterations in the mathematical system, which usually comprises at least one function and is expressed in discrete terms, are performed by means of at least one fixed-point number. All computations may be performed as fixed-point or integer computations. A fixed-point number is represented as an integer type number on a computer, where a virtual decimal point or separator (also referred to as an imaginary decimal separator) is introduced “manually”, i.e. by the programmer, to separate the integer part and the fractional part of the real number. Hence, calculations on fixed-point numbers are performed by simple integer operations, which are identical on all processors in the sense that the same computation, performed on two different processors, yields identical results on the two processors, except for possible different representations of negative numbers. Such possible different representations may occur as a consequence of some processors utilizing ones complement and other processors utilizing twos complement. Furthermore, these operations are also usually faster than the corresponding floating point operations. The use of fixed-point variables is further discussed in section B below.

The mathematical system may comprise at least one non-linear map or at least one non-linear equation, or a set of non-linear maps or a set of non-linear equations, as discussed further below, cf. in particular section C.

The counter referred to above may be increased at each iteration in the mathematical system, in which case a maximum value may be defined for the counter. The method may thus comprise resetting the counter to a minimum value once the counter has reached said maximum value, whereby the counter varies with a certain period. However, this does not necessarily mean that the mathematical system also varies with a period. Resetting the counter avoids overflow in the system.

In order to further improve unpredictability, multiple parameters may be employed. Some of such multiple parameters may be dynamic, i.e. varying, whereas others may be static, i.e. constant. A constant parameter may for example be generated from a seed value provided to the mathematical system, such as an encryption key. The variation of a first one of the parameters, such as of a counter, may be dependent from the variation of a second one of said counters in such a way that the period of the first counter is different from the period of the second counter. The variation of each individual one of the counters may be dependent from the variation of at least another one of said counters so as to obtain a period of the counters which is longer than the period which would have existed if each individual counter would not have been dependent from the variation of another counter. The one or more counters may be increased linearly or by any other function.

The computations performed by the first aspect of the invention may be used for generating pseudo-random numbers, which may be used in any kind of cryptography and/or identification value generation.

2 Manipulation of at Least One of the Most Significant Bits of a Number Resulting from a Multiplication Operation, “G-Function”

In a second aspect, the invention provides a method for manipulating a first set of data in a cryptographic system, the first set of data comprising a first and a second number of a first and a second bit size A and B, respectively, the method comprising:

multiplying the first and the second number to obtain a third number of a third bit size A+B, the third number consisting of P most significant and Q least significant bits, wherein A+B=P+Q, and wherein Q is equal to the largest of the first bit size A and the second bit size B, Q=max(A,B),

manipulating the third number to obtain a fourth number which is a function of at least one of the P most significant bits of the third number,

using the fourth number for deriving an output of the cryptographic system.

More specifically, the fourth number may be used for generating or updating a pseudo-random number as the output of the cryptographic system.

It has been found that a general multiplication function has good cryptographic properties. These properties are good mixing, i.e. most input bits affect all output bits, and poor linear approximations. Furthermore, the multiplication has the property that the number of bits of the output is the same as the total number of bits in the inputs, i.e. If a number of bit-size A is multiplied with a number of bit size B then the output is of bit size A+B. This larger bit size enables further manipulation of the output, such that the final output is of a bit size smaller than A+B, for instance A or B. Thereby improved cryptographic properties for the manipulated multiplication function may be achieved, i.e. all input bits affect all output bits, and all linear approximations are very poor.

The first and second number may have different bit sizes, for example 8 and 16 bit. However, for practical reasons it may be desirable that the first and second numbers are of the same bit size. For example, each of the first and second number may be a 32-bit number, in which case the third number is a 64-bit number, consisting of 32 most significant and 32 least significant bits. The fourth number may then, for example, consist of the 32 most significant bits of the 64-bit number. The first set of data may consist of a single number, such as a number assigned to a variable, and the first number may thus equal the second number, so that the step of multiplying comprises squaring the first number. Such squaring may be advantageous as compared to other multiplication functions implying the multiplication of two different numbers, as it requires handling of a single variable only. Further, the squaring of a number of a certain bit size A results in a number, referred to above as the third number, of bit size 2˜A. Thus, by applying a manipulation to the third number to obtain the fourth number of another bit size, such as bit size A, further complexity is added to cryptographic systems incorporating the method of the second aspect of the invention. The squaring is further advantageous, as it —when performed on small processors, such as 8- or 16-bit processors—requires fewer operations than multiplying two different numbers whereby computational resources may be saved. For example, multiplication of two different 32-bit numbers requires sixteen 8-bit multiplications, whereas the squaring of a 32-bit number only requires ten 8-bit multiplications. Also, by applying the method in a cryptographic system, a keystream of a satisfactory quality (with respect to unpredictability) may be directly generated as a pseudo-random output by means of simple operations, such as by XOR operations. Further, in a cryptographic system, the squaring function does not normally result in a certain result more often than it results in other results. However, the multiplication of two different numbers may results in the result zero every time one of the two numbers being multiplied has the value zero. In other words, the squaring function may have a reduced bias towards a certain result, in particular towards zero, as compared to other multiplication functions. Such bias towards zero may leak information concerning an input to the multiplication, as it reveals that one of the two inputs to the multiplication operation most likely was zero.

The fourth number may itself represent a pseudo-random number which is used as the output of the cryptographic system. Alternatively, the fourth number may be used as an input for further computations, such as iterations in a mathematical system, following which a pseudo-random number or other output of the cryptographic system is derived.

In a cryptographic system one or more state variables may be iterated in a mathematical system. A counter or variable may be added to each or some of the state variables in each or some of the iterative steps, as described further below. The step of multiplying may comprise identical operations in each iterative step, or it may, alternatively, comprise different operations. For example, in a first iterative step, the step of multiplying may comprise squaring a variable x, whereas in one or more subsequent iterative steps, the step of multiplying may comprise multiplying variable x with another variable y.

In the case of at least two state variables being iterated, a value assigned to each of the state variables may be updated as a function of at least one value of the same and/or another state variable, for example according to the general formula xᵢ₊₁=f(xᵢ,yᵢ), subscript i denoting the i'th iteration, x and y denoting the state variables.

The step of manipulating preferably comprises using as well most significant bits of the third number as least significant bits. The manipulating may comprise a logical or arithmetic operation. One logical operation which is easily applied is the XOR function which may, e.g., be applied on a number of most significant bits and an equal number of least significant bits. The XORing may be performed bitswise, in which case each bit of the most significant bits may be XORed with a bit of the least significant bits. The XOR operation may thus be performed N times, resulting in a result of bit size N. The step of manipulating may be performed by applying an operation to bits of two or more different numbers. For example, in a cryptographic system in which several numbers x₁ . . . xₙ are being generated based on iterations of one or more state variables, the step of manipulating may comprise XORing bits of one number xₘ with bits of another number xₚ, one or both of xₘ and xₚ representing the third number.

Likewise, an arithmetic operation may be performed bitwise.

In a cryptographic system, the first and second number may be derived from a set of data to be encrypted or decrypted, in which case the fourth number may be used to generate an encrypted or decrypted representation of the second set of data, such as plaintext or ciphertext, for example in a block cipher algorithm or in an algorithm for determining an identification value for identifying a set of data.

The method according to the second aspect of the invention may also be applied for generating an identification value for identifying a second set of data. In that case, at least one of the first and second number is derived from the second set of data, so that the fourth number is used for generating an identification value identifying the second set of data. The term “identification value” may be a hash value or a cryptographic check-sum which identifies the set of data, cf. for example Applied Cryptography by Bruce Schneier, Second Edition, John Wiley & Sons, 1996. In case a cryptographic key is used as a seed value for the computations, the hash function is usually referred to as a MAC function (Message Authentication Code).

In any application of the method, at least one of the first and second number may be derived from a cryptographic key, i.e. an input value for an algorithm of the cryptographic system which is used for initializing iterations.

In the method of the second aspect of the invention, the first number may equal the second number, in which case the step of multiplying comprises squaring the first number.

In a mathematical system, in which a state variable is iterated, the state variable may be updated as a function of the fourth number, or as a function of a permutation of the fourth number, such permutation comprising, e.g., bitwise rotation of the bits of the fourth number.

With the aim of providing a good mixing and making each output bit of the cryptographic system dependent from as many input bits as possible, the step of multiplying may be performed multiple times, each multiplication being performed on a number which represents or is a function of one of a plurality of state variables, the step of multiplying thereby resulting in a plurality of third numbers. Thus, also the step of manipulating may result in an array comprising a plurality of fourth numbers, whereby at least one state variable may updated as a function of at least two of the fourth numbers.

At least one of the first and second number may be a state value Xᵢ to which there is added a variable parameter value, such as a counter Cᵢ. The step of multiplying may thus comprise squaring (Xᵢ+Cᵢ), Xᵢ denoting a state variable or an array of state variables, and Cᵢ denoting the counter or an array of counters. The at least one parameter may be repeatedly varied at predetermined intervals in the computations. A counter Cᵢ may be added to the fourth number or to a number which is a function of the fourth number to result in an updated state variable Xᵢ₊₁.

The step of multiplying may comprise a plurality of multiplication functions resulting in a plurality of numbers of bit size A+B, whereby the step of manipulating may comprise combining at least one of the bits of a first one of the plurality of numbers with at least one of the bits of a second one of the plurality of numbers. The plurality of multiplication functions may comprise at least one squaring operation, whereby the step of manipulating may comprise combining at least one of the P most significant bits of a first one of the plurality of numbers with at least one of the Q least significant bits of a second one of the plurality of numbers.

The step of multiplying is usually performed in a mathematical system in which at least one state variable is being iterated, most often in a system in which two or more state variables are being iterated. In each computational sequence, values assigned to each of the at least two state variables may be updated as a function of at least one value of the same and/or another state variable.

In a cryptographic application, at least one of the first and second number may be derived from a set of data to be encrypted or decrypted, whereby the fourth number may be used for generating an encrypted or decrypted representation of the set of data. Likewise, the fourth number may be used for generating an identification value identifying the set of data.

At least one of the first and second number may be derived from a cryptographic key.

The method of the second aspect of the invention may advantageously be applied in a system/method, wherein an identification value for identifying a set of data is determined, and wherein a set of data is concurrently encrypted/decrypted, e.g., by means of a pseudo-random number generator in which numerical computations are performed in a mathematical system, cf. the below discussion of the fifth aspect of the invention.

3 Combining of the Quotient and the Remainder of a Number Resulting from a Division Operation

In a third aspect, the invention provides method for manipulating a first set of data in a cryptographic system, the first set of data comprising a first and a second number, the method comprising:

dividing the first number by the second number to obtain a quotient and a remainder,

combining, by means of a mathematical operation, the quotient and the remainder to obtain a resulting number,

using the resulting number for deriving an output of the cryptographic system.

Such manipulating may be applied in the method according to the second aspect of the invention. The step of combining may comprise any manipulating discussed above in connection with the method according to the second aspect of the invention, for example a logical operation, such as an XOR operation, or an arithmetic operation. The output of the cryptographic system may be any output discussed above in connection with the second aspect of the invention.

The method of the third aspect of the invention results in an improved mixing of numbers in a cryptographic system, in particular in a pseudo-random number generator. The method is useful in connection with any cryptographic system, including those described herein.

4 Updating of Counter Values by Means of a Carry Value

With the aim of providing a method for ensuring very long periods of a sequence of numbers in a cryptographic system, and thus with the aim of improving unpredictability and security, there is provided as a fourth aspect of the invention a method for generating a periodic sequence of numbers in a cryptographic system in which computational steps are repeatedly performed, the method comprising updating, in each computational step i, an array of counters, the counters being updated by a logical and/or by an arithmetic function, whereby, at each computational step, a carry value is added to each counter in the array, and wherein the carry value added to the first counter in the array, c₀, is obtained from at least one of:

a selected computation of a value of the array of counters,

a value which is a function of a counter value at a previous computational step.

In other words, the method comprises updating, in each computational step i, an array Cᵢ of counters c_{j,i}, the counters being updated as:

c_{0,i+1}=c_{0,i}+a₀+dᵢmodN₀,

c_{j,i+1}=c_{j,i}+aⱼ+b_{j-1,i+1}modNⱼ for j>0,

where:

c_{j,i+1} is a value assigned to position j of array C at step i+1, j=0 . . . n−1, n denoting a dimension of the array C, i.e. the number of elements in the array,

c_{j,i} is a value assigned to position j of array C at step i, j=0 . . . n−1,

aⱼ is a value, typically a constant, assigned to position j of an array A, j=0 . . . n−1,

for j>0: b_{j-1,i+1} is a carry value resulting from the computation of c_{j-1,i+1},

Nⱼ is a constant, j=0 . . . n−1,

for i=0: dᵢ=d₀ is an initial value,

for i>0 dᵢ is a carry value obtained from a selected computation of a value of the array of counters Cᵢ and/or a function of Cᵢ.

It should be understood that the carry values may be zero.

As demonstrated below, a mathematical proof is established showing that the period of the counter system is very long. Thus, in a pseudo-random number generator employing the above counter system and generating a keystream, huge amounts of data may be encrypted without the keystream becoming periodic by repeating itself. Thereby, unpredictability and security is improved.

It should be understood that the sequences of numbers generated by the method according to the fourth aspect of the invention preferably has a period which is so long that the sequence of numbers generated, in most practical applications, does not become periodic, i.e. that any sequence of numbers generated is not repeated.

The array of counters Cᵢ will below be referred to as a “counter with carry feedback”, in contradiction to an ordinary counter of the form cᵢ₊₁=cᵢ+a mod N. In order to explain the effect of a counter with carry feedback, an ordinary counter will first be discussed:

Consider a system defined by:

cᵢ₊₁=cᵢ+amodN,

where cᵢ is the value of the counter at step i (the array Cᵢ containing a single element, cᵢ), cᵢ₊₁ is the value of the counter at step i+1, a is a constant number and N is a large number usually defined by a register size of an electronic processor which performs the computations, i.e. N=2³² for a 32-bit processor.

In the case where a=1, c is constantly incremented by 1 until it reaches the value N−1, and in the following iteration c restarts from zero. In such a system, the period of c is equal to N. The single bits in the number have, however, different periods. The least significant bit, c^{[0]}, is successively added the value 1, and will thereby repeatedly obtain the values 0 and 1, i.e. have a period of 2. For every second incrementation this will give rise to a carry being added to the next bit in the register, c[^{1]}, which thereby will have a period of 4. For bits at position j, the period will be given by 2^{j+1}.

Such a system suffers from the disadvantage that all bits, except the most significant, have periods smaller than the total period N. Another disadvantage is that the dynamic behaviour of the bits is rather predictable. For instance, the value of the least significant bit changes at every iteration. Thereby, even though the value at a given iteration is not known, the value will be the opposite in the following iteration. Also, the value of the most significant bit will change only when half of the period N has passed. This means that the value of the most significant bit is constant for a long time, resulting in poor non-predictability characteristics which are crucial in cryptographic systems.

As indicated above, the counter with carry feedback, in a single-dimensional system, may be defined by:

cᵢ₊₁=cᵢ+a+d_{imodN,}

dᵢ₊₁=1 if cᵢ+a+dᵢ≧N,

dᵢ₊₁=0 if cᵢ+a+dᵢ<N,

where cᵢ is the value of the counter at step i, cᵢ₊₁ is the value of the counter at step i+1, a is a constant number, dᵢ is the value of the feedback carry at step i, and N is a large number usually equal 2 to the power of the register size of the processor on which computations are being performed.

Again consider the case where a=1, starting with c₀=0, the behaviour is similar to the ordinary counter until cᵢ+a+bᵢ becomes larger than or equal to N, then bᵢ₊₁ is put equal to 1, and in the subsequent iterations added to the value of the counter. Thereby the period 2 behaviour at the least significant bit is interrupted, thereby making it less predictable than in the case of an ordinary counter. This furthermore means that the least significant and the rest of the bits all will have periodic behaviour equal to that of c. This period is N−1.

The period of the counter system with carry feedback can be proven as follows.

The above recurrence relation is equivalent to the following linear congruential generator:

Zᵢ₊₁=Zᵢ+Amod(N−1),

which has a period length of N−1, when A has been chosen such that gcd(A,N−1)=1, i.e. the greatest common divisor of A and N−1 is one, cf. B. Schneier: Applied Cryptography, John Wiley & Sons, Inc. (1996).

To show that Z is equivalent to C, we consider an initial value C₀=Z₀ for Z₀>A. The recurrence relation for C, can be defined in terms of Zᵢ:

Cᵢ=Zᵢ if (Zᵢ₋₁+A)<N−1 and Zᵢ₋₁≠0, A denoting a concatenated value aₙ₋₁ . . . a₀, cf. below,

Cᵢ=N−1 If (Zᵢ₋₁+A)=N−1

Cᵢ=Zᵢ−1 if (Zᵢ₋₁+A)>N−1 or Zᵢ₋₁=0

Therefore, Cᵢ will attain the same set of numbers as Zᵢ, though in a different order, except that Cᵢ will attain the value N−1 but not the value A. Thus, the period of the recurrence relation, C, is the same as for the linear congruential generator, Z.

To sum up, the purpose of the counter system is to generate a sequence of numbers with a given long period, wherein each binary value at each bit-position have the same period as the complete system. Additionally, the least significant bit is, due to the carry feedback, influenced by all other bits, which is not the case when no feedback is applied.

The application of the long periodic sequence is to ensure that the internal state of the stream cipher has a large period.

When the constant incrementation value A is chosen appropriately, it can furthermore be achieved that the values at each bit position in C have relatively high frequencies, i.e. changes often. Thereby, in a situation where the values of the counter bits are secret, for instance when they are applied as part of the input to a stream cipher with an internal state, the exploitation of any relation between the output of the stream cipher and the values of the bits, is additionally complicated since the values of the bits change relatively often.

The value A may be appropriately chosen by ensuring that the product of (N₀*N₂* . . . *Nₙ₋₁)−1 and a concatenated value of the values aⱼ are mutually prime. The concatenated value of the values aⱼ is determined as a single sequence of bits aₙ₋₁aₙ₋₂ . . . a₀, cf. the below example.

An example of appropriate chosen constants, when performing computations with 32-bit registers (i.e. N=2³²), are:

a₀=0x4D34D34D

a₁=1×D34D34D3

a₂=0x34D34D34

a₃=0x4D34D34D

a₄=1×D34D34D3

a₅=0x34D34D34

a₆=0x4D34D34D

a₇=1×D34D34D3

where 0x indicates that the numbers are represented as hexadecimal numbers. The connection to the single counter system with carry feedback, is easily obtained by concatenating all constants and concatenating all counter elements, and thereby performing the calculations on these 256-bit numbers, i.e. with modulus 2²⁵⁶. In the above example, the concatenated value of A is a₇a₆a₅a₄a₃a₂a₁a₀=1xD34D34D34D34D34D34D34D34D34D34D34D34D34D34D34D34D34D34D34D34D34D.

Another example of appropriate chosen constants, when performing computations with 8-bit registers, are:

a₀=0x2C

a₁=1xCB

a₂=1xB2

a₃=0x2C

a₄=1xCB

a₅=1xB2

a₆=0x2C

a₇=1xCB

where 0x indicates that the numbers are represented as hexadecimal numbers. The connection to the single counter system with carry feedback is easily obtained by concatenating all constants and concatenating all counter elements, and thereby performing the calculations on these 64-bit numbers, i.e. with modulus 2⁶⁴.

The counter system with carry feedback as discussed above may be applied for using the counter values as a periodic input for a cryptographic function, e.g.:

Using the counter values as input to a stream cipher or pseudo-random-number-generator with an internal state.

Using the counter values as part of the input in a computation of an identification value.

In one embodiment, an internal state of a cryptographic system is updated as a function of the counter values, e.g. by adding a counter value to an internal state. Such update may be performed before the computation of a next-state value or subsequent to the computation of a next-state value. An output function may then be applied to the current or the next internal state in order to generate a pseudo-random output, often referred to as a “keystream”.

The following pseudo code illustrates a preferred embodiment of the computation of multiple counters, the pseudo code illustrating a single iteration of the counter:

```
// Save old counter values
for i=0 to 2
  c_old[i] = c[i]
end for
// Increase counters
c[0] = (c[0] + a[0] + d) mod 2³²
if c[0] < c_old[0] then
  b[0]=1
else
  b[0]=0
end if
c[1] = (c[1] + a[1] + b[0]) mod 2³²
if c[1] < c_old[1] then
  b[1]=1
else
  b[1]=0
end if
c[2] = (c[2] + a[2] + b[1]) mod 2³²
if c[2] < c_old[2] then
  d=1
else
  d=0
end if
```

The following pseudo code illustrates a preferred embodiment of the computation of a single counter:

```
// Save old counter value
c_old = c
// Increase counter
c = (c + a + d) mod 2³²
if c < c_old then
  d=1
else
  d=0
end if
```

In the above pseudo-codes, it is presumed that all values of a are smaller than 2³²−1.

As will be understood from the above discussion, the size of the arrays C and A may be 1, i.e. n=1, so that:

the array C contains a single value c_{0,i},

the array A contains a single value a₀,

the counter c_{0,i} being updated as c_{0,i+1}=c_{0,i}+a₀+dᵢ mod N₀.

As further described below in connection with FIG. 4, for i>0, dᵢ may be a carry value resulting from the computation of C_{n-1,i}, i.e. the latest carry value computed at a preceding iterative step.

In case the array C only contains a single element c, the number c may be successively incremented by the constant value a, and the value of the carry register d. If c becomes larger than a value N, N is subtracted from the number, i.e. modulus N, and the value in the carry register is set to 1. If the number is less than N, the value in the carry register is set to 0. This procedure can formalistically be described as:

cᵢ₊₁=cᵢ+a+dᵢ

If cᵢ₊₁>=N then dᵢ₊₁=1 else dᵢ₊₁=0

if cᵢ₊₁>=N then cᵢ₊₁=cᵢ₊₁−N

In case the array C contains a plurality of elements or numbers C=(c₀, c₁, c₂, . . . , cₙ₋₁), such numbers may successively be incremented by a set of constant values A=(a₀, a₁, a₂, . . . aₙ₋₁) and values of a set of carry registers (b₀, b₁, b₂, . . . bₙ₋₁), bₙ₋₁=d. If any of the numbers become larger than a value N, N is subtracted from the number in question, i.e. modulus N, and the value in the corresponding carry register is set to 1. The carry register involved in the addition is the carry arising from the neighbour number, such that the set of numbers are coupled by the carry registers to form a chain. The first number is added with the carry register from the last number in the previous incrementation. This procedure can formalistically be described as:

C_{0,i+1}=C_{0,i}+a₀+dᵢ.

If c_{0,i+1}>=N then b_{0,i+1}=1 else b_{0,i+1}=0.

if c_{0,i+1}>=N then c_{0,i+1}=c_{0,i+1}−N.

The rest of the numbers are determined by:

c_{j,i+1}=c_{j,i}+aⱼ+b_{j-1,i-1}.

if c_{j,i+1}>=N then b_{j,i+1}=1 else b_{j,i+1}=0, for j<n−1.

if c_{n-1,i+1}>=N then dᵢ₊₁=1 else d_{i∈}=0.

if c_{j,i+1}>=N then c_{j,i+1}=c_{q,i+1}−N.

The above procedure is graphically illustrated in FIG. 4.

Alternatively, dᵢ may be a carry value determined in the same iteration, that is: firstly a constant is added to the first counter, the carry from this operation and a constant are then added to the next counter in the chain and so forth. This procedure is continued until and including the last counter in the chain, the carry from this last addition is then added to the first counter, and if a carry occurs it is added to the next counter and so on. The procedure is illustrated in the following pseudo-code:

```
// Save old counter values
for i=0 to 2
  c_old[i] = c[i]
end for
// Increase counters
c[0] = (c[0] + a[0]) mod 2³²
if c[0] < c_old[0] then
  b[0]=1
else
  b[0]=0
end if
c[1] = (c[1] + a[1] + b[0]) mod 2³²
if c[1] < c_old[1] then
  b[1]=1
else
  b[1]=0
end if
c[2] = (c[2] + a[2] + b[1]) mod 2³²
if c[2] < c_old[2] then
  d=1
else
  d=0
end if
// Add final carry
c[0] = (c[0] + d) mod 2³²
if c[0] < c_old[0] then
  b[0]=1
else
  b[0]=0
end if
c[1] = (c[1] + b[0]) mod 2³²
if c[1] < c_old[1] then
  b[1]=1
else
  b[1]=0
end if
c[2] = (c[2] + b[1]) mod 2³²
```

In the above pseudo-code, it is presumed that all values of a are smaller than 2³²−1.

The computational steps which are performed in the cryptographic system usually comprise an iterative procedure in which an array of state variables, X, is repeatedly iterated so that at least one value assigned to a position in the array of state variable X at computational step i+1 is a function of:

at least one value assigned to a position in the array of state variables X at computational step i, and

at least one value assigned to a position of the array of counters C at computational step i.

For example, Xᵢ₊₁ may be computed according to the general formula Xᵢ₊₁=f(Xᵢ, Cᵢ), such as Xᵢ₊₁=f(Xᵢ+Cᵢ). It should be understood that the array X may contain one or more state variables.

The method of the second aspect of the invention may advantageously be applied in a system/method, wherein an identification value for identifying a set of data is determined, and wherein a set of data is concurrently encrypted/decrypted, e.g., by means of a pseudo-random number generator in which numerical computations are performed in a mathematical system, cf. the below discussion of the fifth aspect of the invention.

Combination of Carry-Updating of Counters and “G-Function”

In a further aspect, the invention provides a method for generating an output in a cryptographic system, the method combining the general concepts underlying the second and the fourth aspects of the invention. Thus, according to the sixth aspect of the invention, computational sequences may performed as an iterative procedure wherein an array of state variables, X, is repeatedly iterated so that at least one value assigned to a position in the array of state variables X at iteration step i+1 is a function of:

at least one value assigned to a position in the array of state variables X at iteration i, and

at least one value assigned to a position of an array of counters C at iteration i, the array of counters being updated in each iteration as:

c_{0,i+1}=c_{0,i}+a₀+dᵢmodN₀,

c_{j,i+1}=c_{j,i}+aⱼ+b_{j-1,i+1}modNⱼ for j>0,

where:

c_{j,i+1} is a value assigned to position j of array C at step i+1, j=0 . . . n−1, n denoting a dimension of the array C,

c_{j,i} is a value assigned to position j of array C at step i, j=0 . . . n−1,

aⱼ is a value assigned to position j of an array A, j=0 . . . n−1,

for j>0: b_{j-1,i+1} is a carry value resulting from the computation of c_{j-1,i+1},

Nⱼ is a constant, j=0 . . . n−1,

for i=0: dᵢ=d₀ is an initial value,

for i>0 dᵢ is a carry value obtained from a selected computation of a value of the array of counters Cᵢ and/or a function of Cᵢ,

each iteration comprising:

multiplying a first number of a first bit size A and a second number of a second bit size B to obtain a third number of a third bit size A+B, at least one of the first and second number being equal to or a function of at least one value assigned to a position of the array of state variables X at iteration 1, the third number consisting of P most significant and Q least significant bits, wherein A+B=P+Q, and wherein Q is equal to the largest of the first bit size A and the second bit size B, Q=max(A,B),

manipulating the third number to obtain a fourth number which is a function of at least one of the P most significant bits of the third number,

using the fourth number for deriving the output of the cryptographic system and/or for assigning new values to positions of the array of state variables X.

The above method combines the qualities of the methods according to the second and fourth aspects of the invention, i.e. good mixing of bits and long counter periods, with the overall aim of improving unpredictability.

It should be understood that any feature and functionality described above in connection with the second and fourth aspects of the invention may be applied in the method of the present aspect of the invention.

The present aspect of the invention will be further discussed below in connection with FIGS. 1-5.

5 Concurrent Encryption and Identification Value Generation

In a further aspect, the invention provides a method of determining an identification value for identifying a set of data and for concurrently encrypting and/or decrypting the set of data. The method preferably comprises performing numerical computations in a mathematical system exhibiting a positive Lyapunov exponent, the method further comprising at least one of the following steps:

repeatedly performing mathematical computations as iterations in the mathematical system, whereby various parts of the set of data or modifications thereof may be used as input to the computations,

following each computation or a certain number of computations:

extracting a resulting number from the computations, the resulting number representing at least one of:

a. at least a part of a solution to the mathematical system, and

b. a number usable in further computations involved in the numerical solution of the mathematical system,

optionally determining an updated value for the identification value based on the resulting number, whereby various parts of the set of data or modifications thereof may be used as input in the step of determining,

encrypting and/or decrypting a certain portion of the set of data based on the resulting number,

whereby as many iterations are performed as required for encrypting and/or decrypting the entire set of data.

The use of one or more fixed-point variables may confer advantages related to reproducibility and computational speed, cf. section B below. By performing encryption/decryption and identification value generation concurrently, computational resources may be saved.

Encryption and/or decryption and determining the identification value may be performed in the same process or in distinct processes, i.e. for example in such a way that the entire set of data is processed in order to obtain an intermediate result which is then used as an input for further computations which yield the identification value and the encrypted and/or decrypted version of the set of data.

The method may comprise:

expressing the mathematical system in discrete terms,

expressing at least one variable of the mathematical system as a fixed-point number,

performing said computations in such a way that the computations include the at least one variable expressed as a fixed-point number, fixed-point variables and numbers being discussed further above in connection with the first aspect of the invention and in section B below.

The identification value may be further modified following encryption and/or decryption of the entire set of data.

Encryption/decryption and determination of the identification value can take place at the same time or in parallel. The identification value can be a hash value, a check-sum or a MAC (Message Authentication Code), see the above description. In some cases, the calculation of identification value and the encryption process takes place sequentially. However, it can also be done in one working process or instance, in parallel or at the same time. This may be done in order to reduce the number of computations and/or to be able to process a sequence of data as it becomes available or is given to an algorithm which embodies the mathematical system, or to increase ease-of-use. The identification value can be calculated with or without a key.

The identification value may be related to a specific message, i.e. the message must be used as input to the algorithm. Instead of first encrypting the message and then running through the entire message again to calculate the identification value, the two methods may be combined, i.e. in each iteration of the mathematical system, a pseudo-random number may be extracted and combined with the message in order to encrypt/decrypt, after which the identification value may be updated. After each iteration this intermediate identification value may be stored.

In the method according to the present aspect of the invention, a mathematical system may be defined, the mathematical system exhibiting a positive Lyapunov exponent. The method may comprise the following steps:

1. Defining a key/seed value.

2. Performing computations on the mathematical system, and/or

3. Performing computations on the mathematical system and the message.

4. Extracting a pseudo-random number.

5. Calculating a new intermediate identification value.

6. Continuing step 2-5 until the entire message has been used in the computations performed on the mathematical system and the message.

7. Calculating the final identification value based on the intermediate identification value.

In an alternative embodiment, the method may comprise the following steps:

1. Defining a key/seed value.

2. Performing computations on the mathematical system and the message.

3. Extracting a pseudo-random number.

4. Continuing step 2-3 until the entire message has been used in the computations performed on the mathematical system and the message.

5. Determining the final identification value from variables in the mathematical system.

In the method, the

message may be plaintext or ciphertext,

message may be used as input to some or all of the calculations,

the pseudo-random number may be used to encrypt/decrypt the message by means of logical and/or artithmetical operations,

at least one variable is expressed in fixed-point format.

In case of a block cipher, no pseudo-random numbers are generated, in which case step 3 above is substituted by the step of manipulating a block or part of message in order to encrypt and/or decrypt it.

In one embodiment, the calculation of the identification value is dependent on a key.

In a mathematical system exhibiting a positive Lyapunov exponent computations may be performed using fixed-point arithmetic, whereby a cryptographic key (as described for a stream cipher) is used as an initialization value. This key, or part thereof, is also used to initialize the identification value.

The determination of the identification value and encryption of a set of data, message, or plaintext, is then performed by

1. Iterating the mathematical system one step.

2. Extracting a number of n pseudo-random bits from the system.

3. Selecting the next n bits of the data, message, or plaintext.

4. Using a function, F_{H}, to obtain a new value for the identification value, given the extracted bits, the selected bits of the data, message or plaintext and the old value of the identification value.

5. Applying the logical XOR function on the n pseudo-random bits and the selected n bits thereby encryption the selected n bits of the data, message or plaintext.

6. Steps 1 through 5 are repeated until all bits are encrypted.

7. The system may be iterated further to extract more pseudo-random bits.

8. Further computations may be performed on the identification value to obtain a final identification value.

The generated identification value can be combined with the encrypted message, and the result can e.g. be transmitted over the Internet to a receiver.

When decrypting and recalculating the identification value, the algorithm is initialized in same manner as for encryption. Then the following steps are performed:

1. Iterating the mathematical system one step.

2. Extracting n pseudo-random bits from the mathematical system.

3. Selecting the next n bits of the encrypted data/message.

4. Applying the logical XOR function on the encrypted bits to decrypt these.

5. Using a function, F_{H}, to obtain a new value for the identification value, given the extracted bits, the bits to be decrypted and the old value of the identification value.

6. Repeating steps 1 through 5 until all bits are decrypted.

7. The system may be iterated further to extract more pseudo-random bits.

Further computations may be performed on the identification value to obtain a final identification value.

End of Section 5.

It should be understood that the present invention also extends to any apparatus and to any computer program for carrying out all the methods of the invention, including electronic devices incorporating digital signal processors. The invention also extends to data derived from any method and/or computer program of the present invention and any signal containing such data do also fall within the scope of the appended claims. It should further be understood that any feature, method step, or functionality described below in connection with the further aspects of the invention discussed below may be combined with the method of the first aspect of the invention.

Further features and functions which may be employed in the various aspects of the invention, and definitions applicable to the aspects of the present invention, are discussed below. The below considerations apply, where appropriate, to all aspects/methods of the present invention.

A General Definitions and Considerations

Where in the present context, the term “pseudo-random number” is used, this should be understood as a random number which may be generated in a reproducible and/or deterministic way, i.e. in a way that results in the same pseudo-random number being generated in two different executions of a pseudo-random number generating algorithm when the same key or seed value is used as an input for the pseudo-random number generating algorithm in the two executions.

In general, a mathematical system may comprise a system which expresses certain relations between variables. For example, such relations may be constituted by mathematical operations, including discrete operations, such as binary and/or logical operations. Thus, mathematical operations may comprise multiplication, division, addition, subtraction, involution, AND, OR, XOR, NOT, shift operations, modulus (mod), truncation and/or rounding off.

Numerical computations may involve computations in which numbers are manipulated by mathematical operations.

A counter is herein defined as a variable which may serve as a parameter in a mathematical system. The counter is continuously iterated and updated by means of a mathematical function. Such a function may, e.g., be a simple addition, cᵢ₊₁=cᵢ+a, where cᵢ₊₁ represents the counter value at iteration step i+1, cᵢ represents the counter value at iteration step i, and a a number added to cᵢ. The function may alternatively be more sophisticated and include linear and/or non-linear operations and/or logical operations. Preferably, the counter varies independently of the mathematical system in which the counter is used as a parameter.

In the present context, the term “data carrier” or “computer readable data carrier” should be understood as any device or media capable of storing data which is accessible by a computer or a computer system. Thus, a computer readable data carrier may, e.g., comprise a memory, such as RAM, ROM, EPROM, or EEPROM, a CompactFlash Card, a MemoryStick Card, a floppy or a hard disk drive, a Compact Disc (CD), a DVD, a data tape, or a DAT tape.

Signals comprising data derived from the methods of the present invention and data used in such methods may be transmitted via communications lines, such as electrical or optical wires or wireless communication means using radio or optical transmission. Examples are the Internet, LANs (Local Area Networks), MANs (Metropolitan Are Networks), WANs (Wide Area Networks), telephone lines, leased lines, private lines, and cable or satellite television networks.

In the present context, the term “electronic device” should be understood as any device capable of processing data by means of electronic or optical impulses. Examples of applicable electronic devices to the methods of the present invention are: a processor, such as a CPU, a microcontroller, or a DSP (Digital Signal Processor), a computer or any other device incorporating a processor or another electronic circuit for performing mathematical computations, including a personal computer, a mainframe computer, portable devices, smartcards, chips specifically designed for certain purposes, e.g., encryption. Further examples of electronic devices are: a microchip adapted or designed to perform computations and/or operations, and a chip which performs binary operations.

Processors are usually categorized by: (a) the size of data that is operated on (b) the instruction size and (c) the memory model. These characteristics may have different sizes, normally between 4 and 128 bit (e.g. 15, 16, 32, 64 bit) and not limited to powers of two.

In the present context, the term “processor” covers any type of processor, including but not limited to:

“Microcontroller”, also called “embedded processor”. The term “microcontroller” and “embedded processor” usually refers to a small processor (usually built with fewer transistors than big processors and with limited power consumption). Examples of microcontroller architectures are:

Z80

8051 (e.g. produced by intel)

CPU8/6800 (e.g. 68HC05 68HC08 and 68HC11 e.g. produced by Motorola)

CPU32/68k (e.g. 68000 Dragonball produced by Motorola)

Other processors which are typically used in different kinds of computer and control systems, examples of architectures being:

Alpha 21xxx (e.g. 21164, 21264, 21364)

AMD x86-64 (e.g. Sledgehammer)

ARM (e.g. ARM10, StrongARM)

CPU32/68k (e.g. 68000, 68030, 68040 e.g. produced by Motorola)

IA32 (e.g. the x86 family produced by intel (e.g. i486, Pentium), AMD (e.g. K6, K7), and Cyrix)

IA64 (e.g. Itanium produced by HP/Intel)

MIPS (e.g. R4000, R10000 produced by SGI)

PA-RISC (e.g. 8000, produced by HP)

PowerPC (e.g. G3, G4, produced by IBM/Motorola)

SPARC (e.g. UltraSPARC II, UltraSPARC III, produced by SUN)

DSPs. Examples are:

DSP56300 (produced by Motorola)

MSC8100 (produced by Motorola)

TI TMS320C6711 (produced by Texas Instruments).

In the present context, the term “register” should be understood as any memory space containing data, such as a number, the memory space being for example a CPU register, RAM, memory in an electronic circuit, or any data carrier, such as a hard disk, a floppy disk, a Compact Disc (CD), a DVD, a data tape, or a DAT tape.

It should be understood that the present invention also relates to, in independent aspects, data derived from the methods of the present invention. It should also be understood that where the present invention relates to methods, it also relates to, in independent aspects, computer programs being adapted to perform such methods, data carriers or memory means loaded with such computer programs, and/or computer systems for carrying out the methods.

Any and all computational operations involved in the methods of the present invention may be carried out on or by means of an electronic device.

In one aspect, which constitutes an independent aspect of the present invention, a method of performing numerical computations in a mathematical system comprising at least one function, the method comprising the steps of:

expressing the mathematical system in discrete terms,

expressing at least one variable of the mathematical system as a fixed-point number,

performing said computations in such a way that the computations include the at least one variable expressed as a fixed-point number,

obtaining, from said computations, a resulting number, the resulting number representing at least one of:

a. at least a part of a solution to the mathematical system, and

b. a number usable in further computations involved in the numerical solution of the mathematical system,

the method further comprising:

extracting a set of data which represents at least one of:

i. a subset of digits of the resulting number, and

ii. a subset of digits of a number derived from the resulting number.

A subset of a number may be regarded as a part of that number, such as some, but not necessarily all digits or bits of the number. For example, the 8 least significant bits of a 16-bit number may be regarded as a subset of the 16-bit number.

The term “extracting” covers, but is not limited to: outputting the number or subset in question, for example as a keystream or a part of a keystream or as any other final or intermediate result of a computational process; storing the number or subset in question in a register, for example in order to allow for further use thereof, such as for further computations, on the subset.

By extracting a subset of digits of a number instead of extracting the entire number, random properties are improved in case the method is used in a pseudo-random number generator, for example for encryption and/or decryption purposes. Moreover, as only a subset is extracted, less information concerning the internal state of the mathematical system is contained in the extracted set of data which enhances the security of an encryption/decryption system incorporating the method.

Though the mathematical system may comprise a continuous system, for example a system of differential equations, it may also or alternatively comprise a system which is originally defined in discrete terms, for example in the case of a map. The at least one function of the mathematical system may be non-linear, as discussed in more detail in section C below.

Usually, the subset of digits comprises k bits of an m-bit number, k≦m, for example extracting 8 bits of a 32-bit number. The number from which the subset is extracted and/or the extracted set of data may be expressed as one or more binary number, octal number, decimal numbers, hexadecimal number, etc. The k bits may be the least significant bits of the number, or it may be k bits selected from predetermined or random positions within the number from which the bits are extracted. For example, from a 64-bit number, bits Nos. 42, 47, 53, 55, 56, 57, 61, and 63 may be extracted, or bits Nos. 47-54.

In the methods of the present invention, one or more computations may be performed as floating-point operations. The step of expressing at least one variable of the mathematical system as a fixed-point number may thus comprise converting a floating-point type number to an integer type number, optionally performing a certain manipulation on the integer number, for example truncating it, and converting the integer number back to a floating-point type number.

The methods of the invention may be applied for encryption and decryption, modulation of radio waves, synchronization of chaos in picture and sound signals so as to reduce noise, data compression, in control systems, watermarking, steganography, e.g. for storing a document in the least significant bits of a sound file, so as to hide the document in digital transmission.

Many SIM-cards and smart cards exhibit weaknesses to power analysis attacks, which exploits the fact that the power consumption is directly related to the arithmetic functions performed by the processor. To avoid this, a program for executing one of the methods described herein may randomly execute some operations which only function is to disrupt the systematic power consumption. The pseudo-random number generator may be used to determine the operations to be performed.

The pseudo-random number generator can be used to generate keys for other encryption algorithms, i.e. asymmetric or public-key algorithms. For example, it could be used to generate pseudo-random numbers used to calculate at least one prime number. In this way it is possible to generate the public and private key pair used in the RSA algorithm.

In the present context, the term “resulting number” should be understood as any number occurring in the computations. More than one resulting number may be obtained. The resulting number may, as stated above, be a part of the solution to the mathematical system and/or an intermediate result, i.e. a number assigned to any variable or parameter of the mathematical system or to any other variable or parameter used in the computations. In an implementation of a mathematical method, the resulting number or a part thereof may be extracted, for example as a pseudo-random number for use in an encryption/decryption system. Alternatively, one or more mathematical and/or logical operations may be performed on the resulting number or on a plurality of resulting numbers, so as to obtain a further number which is extracted. All or only selected bits in a binary representation of the resulting number may be extracted. It should be understood that a number generated from selected bits of a number occurring in the computations may be referred to as the resulting number. Thus, the term “resulting number” also covers any part of a number occurring in the computations.

The methods of the invention are, as discussed above, useful in cryptography, for example in the following implementations: a symmetric encryption algorithm, a public key (or asymmetric key) algorithm, a secure or cryptographic Hash function, or a Message Authentication Code (MAC). These algorithms may, for example, be used in accomplishing one or more of the following tasks:

Ensuring confidentiality of digital data, so as to protect data from unauthorized access.

Ensuring integrity of digital data, so as to ensure that information is accurate or has not been tampered with.

Authorization, e.g. to allow permission to perform certain tasks or operations.

Authentication, such as user authentication, so as to verify the identity of another party, or data origin authentication, so as to verify the origin of the data.

Nonrepudiation, to provide proof of participation in an electronic transaction, for example to prevent that a first person A sends a message to a second person B and subsequently denies that the message has been sent. Digital signatures are used for this purpose. The generation of a digital signature may incorporate the use of a public key algorithm and a hash function.

The methods of the invention are also applicable to a so-called Hash function. A Hash function provides a kind of digital fingerprint wherein a small amount of data serves to identify other data, usually a set of data which is considerably larger than the aforementioned small amount of data. Hash functions are usually public functions wherein no secret keys are involved. Hash functions can also provide a measure of authentication and integrity. They are often essential for digital signature algorithms and for protecting passwords, as a Hash value of a password may be used for password control instead of the password itself, whereby only the hash value and not the password itself needs to be transmitted, e.g. via a communications network.

A Hash function employing a secret key as an input is often referred to as a MAC algorithm or a “keyed Hash function”. MAC algorithms are used to ensure authentication and data integrity. They ensure that a particular message came from the person or entity from whom it purports to have come from (authentication), and that the message was not altered in transit (integrity). They are used in the IPsec protocols (cf. RFC 2401 available on http://www.rfc-editor.org on 6 Jun. 2003), for example to ensure that IP packets have not been modified between when they are sent and when they reach their final destination. They are also used in all sorts of interbank transfer protocols.

As discussed above, the methods of the invention may be implemented in a Hash or a MAC algorithm. A Hash or a MAC algorithm calculates a checksum of an amount of data of an arbitrary length, and gives the checksum as a result. The process should be irreversible (one-way), and a small change of an input value should result in a significantly different output. Accordingly, the sensitivity to data input should be high. Whereas a Hash function does not use a key as a seed value, a MAC algorithm uses such a key which represents or determines a seed value for the algorithm, whereby the result depends on the key. Instead of a key, the Hash function relies on a constant value, for example certain bits from the number π. Alternatively, a part of the data to which the Hash function is applied may be used as a seed value.

A Hash/MAC algorithm may be implemented as follows:

A mathematical system in the form of a logistic map is used in the algorithm, the logistic map having the form: xₙ₊₁=λxₙ(1−xₙ), wherein λ is a parameter. Other chaotic systems may be employed, such as the Lorenz system which is discussed in detail hereinafter.

As the result of the algorithm should depend on the message m for which the checksum is to be calculated, the message is incorporated in the system as a component thereof. For example, a kind of coupling between the message and the dynamic variable, x, may be performed as follows: xₙ₊₁=λxₙ(1−xₙ)+ε(xₙ−mₙ).

The parameters λ and ε and the initial value x₀ may be predetermined and/or derived from the message. In the case of a MAC algorithm, the parameters λ and ε and the initial value x₀ may, completely or partially, be determined by the secrete key.

The system is iterated until the end of the message is reached. The last calculated value of x or part thereof, such as the least significant digits, is denoted, for example, the Hash value, the MAC or the checksum. Alternatively, a number of additional iterations may be performed prior to extracting the resulting number. Instead of or in addition to extracting the last calculated value of x, certain bits which have been ignored in the computations may be extracted as the Hash value.

The way of introducing the message, m, into the dynamical system can be varied. As an example, a part of the message may be used to influence the x-variable in each iteration. Such influence may, e.g., be achieved by XORing certain bits of the message into the least significant digits of x.

For further details concerning Hash/MAC functions, reference is made to Applied Cryptography by Bruce Schneier, Second Edition, John Wiley & Sons, 1996.

One possible field of use of the method of the methods of the invention is public-key encryption, also referred to as asymmetric algorithms. The key used for decryption is different from the key used for encryption. For example, a key-generation function generates a pair of keys, one key for encryption and one key for decryption. One of the keys is private, and the other is public. The latter may for example be sent in an unencrypted version via the Internet. The encryption key may constitute or contain parameters and/or initial conditions for a chaotic system. A plaintext is used to modulate the chaotic system which is irreversible unless initiated by the private key. For decryption, a mathematical system is used which has dynamics which are inverse to the dynamics of the system used for encryption.

B Fixed-Point Variables

Fixed-point variables are mentioned in section 1 above and will now be further discussed, starting from a brief discussion of certain disadvantages related to floating point variables which arise in connection with certain cryptographic methods.

The utilization of floating point variables in the numerical solution of mathematical systems may create non-predictable truncation and/or rounding errors. In case of the mathematical system to be solved being non-linear, and in particular in case of the system being chaotic, the accuracy of the solution at all integration steps is of paramount importance, as a small deviation at one step may confer huge deviations at subsequent steps. If the truncation and/or rounding errors are created consistently in the same manner in any and all computations, two solutions based on the same initial conditions are identical, and accordingly the computations are reproducible. However, in most cases truncation and/or rounding errors of floating point numbers are not entirely controlled by software but also by hardware on which the software is running. Accordingly, truncation and/or rounding errors are hardware dependent, and consequently truncations and/or roundings may be performed differently in two different hardware processors. For most computations this is without importance, as the truncations and roundings create inaccuracies of an order of magnitude which is far below the required accuracy of the computations. But in the solution of, e.g., chaotic systems, a small deviation in the way truncations are performed may confer huge deviations in the solution at later computational steps.

Therefore, with the aim of being able to control, by software, truncation or rounding errors created by hardware, the present inventors have proposed the use of fixed-point variables.

In general, a fixed-point number type is denoted Φ(α.β) where α is the number of bits used to hold the integer part, and β the number of bits to hold the fractional part. The values of α and β, and thus the position of the decimal point, are usually predetermined and stationary. The fixed-point number can be either unsigned or signed, in which case Φ is denoted U or S respectively. In the latter case, a bit is needed to hold the sign, thus α+β+1 bits are needed to hold S(α.β).The range of U(α.β) is [0;2^{α}−β^{-β}], and the range of S(α.β) is [−2^{α};2^{α}−2^{-β}]. The resolution of the fixed-point numbers is thereby 2^{-β}.

The position of the decimal separator in a fixed-point number is a weighting between digits in the integer part and digits in the fraction part of the number. To achieve the best result of a calculation, it is usually desired to include as many digits after the decimal separator as possible, to obtain the highest resolution. However, it may also be important to assign enough bits to the integer part to ensure that no overflow will occur. Overflow is loading or calculating a value into a register that is unable to hold a number as big as the value loaded or calculated. Overflow results in deletion of the most significant bits (digits) and possible sign change.

In the various aspects of the present invention, the position of the decimal separator may be assigned at design time. To choose the right position, the possible range of the number, for which the position is to be chosen, is preferably analyzed. The most positive and most negative possible values are determined, and the highest absolute value of the two is inserted into the following formula:

α=ceil(log₂(abs(MaxVal)))

to determine the value of α.

The position of the decimal point may vary between different fixed-point variables. However, addition and subtraction operations require input numbers with similar positions. Hence, it is sometimes necessary to shift the position of the decimal point. Right shift by n bits corresponds to a conversion from Φ(α.β) to Φ(α+n.β−n). Left shift by n bits will convert Φ(α.β) to Φ(α−n.β+n).Conversion of unsigned numbers is done by logical shift operations, whereas arithmetical shifts are used for signed numbers.

The mathematical operations addition, subtraction, multiplication and division on fixed-point numbers are carried out as plain integer operations. The addition and subtraction operations may result in a number of size Φ(α+1.β) because of the carry. However, the result is normally truncated to give a number with the same format as the input.

Multiplication and division do not require arguments with similar positions of the decimal separators. However, prior to division, the numerator is expanded as it must have twice the length of the denominator and the result. The results will have a format of: S(α.β)·S(c.d)=S(α+c+1.β+d) and S(α+c+1.β+d)/S(α.β)=S(c.d). For unsigned multiplication and division S(α+c+1.β+d) is replaced by U(α+c.β+d). Exceeding digits in the multiplication compared to the predetermined result format are cut off to match the target register size.

A fixed-point number may be handled by representing the integer part of the fixed point number in one register, and representing the fractional part in another register.

Further information on fixed-point calculations can be found in “Fixed-Point Arithmetic: An Introduction” by R. Yates (The text can be found at http://personal.mia.bellsouth. net/lig/y/a/yatesc/fp. pdf on 6 Jun. 2003).

In the present context, a fixed-point variable is defined as an integer type number with an imaginary decimal separator, an integer being defined as a number without digits after the decimal separator. Accordingly, real numbers are represented by inserting the imaginary decimal separator (or decimal point) at some fixed predetermined position within an integer, for example four digits from the left. The position might be changed as a consequence of a mathematical operation on the number. The position may also be forced to be changed by use of a logical operation.

As it occurs from the above discussion, fixed-point numbers are integers, on which a virtual decimal separator is imposed. The number consists of a so-called “integer part”, referring to the bits before the decimal separator, and a “fraction part” referring to the bits after the decimal separator. In the present context, bits are also referred to as digits and vice versa.

In a computer program comprising fixed-point number computations or in an electronic circuit or device for performing fixed-point computations, means may be provided for determining a suitable location of the decimal separator. Thus, the program, circuit or device may, during computations, detect possible overflow and, in the case of a possible overflow being detected, change the number of bits on either side of the decimal separator, i.e. the location of the decimal separator in a register which stores the variable or variables in question. This change may be performed by moving the decimal separator one or more positions to the left or to the right. Preferably as many bits as possible are used to the right of the decimal separator in order to minimize the number of possible unused bits in the register and thereby to obtain an optimal accuracy in the computations. By changing the position of the decimal separator, though some computational speed may be lost due to the requirement for additional operations for detecting possible overflow, the accuracy of the computations is optimized while the risk of overflow is eliminated or reduced, without a designer or programmer of an application incorporating the computer program, circuit or device needing to make considerations concerning accuracy and overflow in a design or programming phase. Alternatively, or additionally, a test program may be provided which determines when or where in the computations overflow will occur or is likely to occur, so that a programmer or designer of the program may fix the position of the decimal separator in one or more variables such that no overflow occurs, whereby, in the final implementation, no determination of possible overflow is needed. However, the determination of possible overflow may also be incorporated in the final implementation as an additional safeguarding feature. Further, the programmer or designer may choose to implement changing of the decimal separator at fixed, predetermined stages in the computations.

As discussed above, a real number may be expressed by means of one or more fixed-point numbers. Likewise, a complex number, c=a+ib, where i²=−1, may be expressed by means of one or more fixed-point numbers, e.g. by expressing the real part a and/or the imaginary part b as a fixed-point number. In case only one of the real and imaginary parts is expressed as a fixed-point number, the other one may be expressed by means of any other type of number, such as a floating-point or an integer number.

In the methods according to the invention, the computations involving the variable expressed as a fixed-point number may possibly include computations on other types of variables, including one or more variables expressed as other kinds of numbers, such as floating point numbers and integer numbers.

The use of fixed-point numbers has the advantage over floating-point numbers that rounding and/or truncations errors occurring in fixed-point number computations are identically defined on all processors. By use of fixed-point variables, decimal numbers may be expressed as integer type numbers where an imaginary decimal separator is placed in the number. In cases where floating-point variables are used, truncation/rounding errors are not performed identically on different types of processors.

As a consequence of truncation/rounding errors being controllable or predictable, numerical computations in mathematical systems which are sensible to truncation/rounding errors may be performed in a reproducible manner. Thus, for example, non-linear systems, in particular chaotic systems, may be numerically solved in a reproducible manner. This opens up for utilizing chaotic systems in pseudo-random number generators, such as in encryption/decryption algorithms, without the need for feed-back or correction algorithms or registers in order to prevent inaccuracies, or without the need for synchronization techniques ensuring identical solution of the systems in encryption as in decryption. This in turn contributes to the computations, the pseudo-random number generation and/or the encryption/decryption algorithm being fast as compared to algorithms involving such feed-back or correction algorithms or synchronization techniques. Further, there is no need for transmission of synchronization data with the encrypted data, such synchronization data often amounting to a size comparable to the size of the encrypted data, which may be a major problem due to, e.g., lack of bandwidth when transmitting data via the Internet. Further, transmission of such data compromises the security of the system. The computations are also performed faster than computations in methods involving a floating-point variable for the variable in question, as in computations involving fixed-point numbers the hardware processor performs computations as integer number computations, computations on integer number being generally faster than computations on floating-point numbers.

C Applicable Mathematical Systems and Computer Implementation Thereof, in Particular with a View to Cryptographic Applications

In the methods described herein, the mathematical system may be a discrete or a continuous system. Various types of mathematical systems are discussed below.

The computations may involve at least a first and a second fixed-point number, each fixed-point number having a decimal separator, wherein the decimal separator of the first fixed-point number is positioned at a position different from the position of the decimal separator of the second fixed-point number. The decimal separator of the first and second fixed-point number may be positioned at selected positions.

The resulting number may be expressed as a variable selected from the group consisting of:

an integer number,

a floating point number, and

a fixed-point number.

In general, the mathematical system may comprise one or more differential equations, or one or more discrete maps or mappings. In the case of differential equations, the mathematical system may comprise one or more ordinary differential equations and/or one or more partial differential equations. In the case discrete mappings, the mathematical system may comprise one or more area-preserving maps and/or one or more non area-preserving maps. At least one function of the mathematical system may be non-linear.

The method is also applicable to other types of functions or equations, including integral equations. The at least one non-linear differential equation or mapping may exhibit chaotic behavior, i.e. it may have at least one positive Lyapunov exponent, in which case the method may comprise computing a Lyapunov exponent at least once during the mathematical computations. In case of a mathematical system exhibiting chaotic behavior, the method may advantageously be applied in a pseudo-random number generating method, such as in an encryption/decryption method. At least one Lyapunov exponent may be computed at least once during the mathematical computations in order to determine whether the mathematical system exhibits chaotic behavior. If this is not the case, e.g. if the computed Lyapunov exponent is not positive, the computations may be interrupted and resumed from other initial values and/or other parameters.

The at least non-linear differential equation or mapping preferably governs at least one state variable, X, which may be a function of at least one independent variable, t.

More specifically, the mathematical system may comprise one or more of the following systems:

continuous differential equations, including:

partial differential equations, such as the Navier-Stokes equations,

ordinary differential equations, including:

autonomous systems, such as dissipative flows, including the Lorenz system, coupled Lorenz systems, the Rössler system, coupled Rössler systems, hyper chaotic Rössler system, the Ueda system, simplest quadratic dissipative chaotic flow, simplest piecewise linear dissipative chaotic flow

Hamiltonian systems, including the N body problem from celestial mechanics, for N≧3,

Non-autonomous systems, including forced systems, such as the forced Duffing's equation, forced negative resistance oscillator, forced Brusselator, forced damped pendulum equation, coupled pendulums, forced double-well oscillator, forced Van de Pol oscillator,

delay differential equations, including delay logistic equation, population models,

Discrete mappings, including

area preserving as well as non area-preserving maps, including

maps which are piecewise linear in any dimension, such as a tent map, an asymmetric tent map, 2× modulo 1 map, and also the Anosov map, the generalized Baker's map, the Lozi map, as well as higher order generalizations and/or couplings of piecewise linear maps

polynomial maps (quadratic or higher), including a logistic map, the Hénon map, higher order generalizations and/or couplings of polynomial map, e.g. N coupled logistic maps, N coupled Hénon maps,

Trigonometric maps, including a Sine circle map, a Sine map, the Chirikov standard map, the Sinai map, the standard map, and Higher order generalizations and/or couplings of trigonometric maps,

other maps, including the Bernoulli shift, a decimal shift, the Horseshoe map, the Ikeda map, a pastry map, a model of a digital filter, a construction of the Hénon type map in two dimensions from an arbitrary map in one dimension, the DeVogelaere map,

Cellular automata,

Neural networks.

The Rössler system referred to above has the form:

$$\begin{matrix}\frac{ⅆ x}{ⅆ t} = - y - z \\ \frac{ⅆ y}{ⅆ t} = x + a y \\ \frac{ⅆ z}{ⅆ t} = b + z ( x - c )\end{matrix}$$

wherein typical parameter values are: a=b=0.2, c=5.7. The Rössler system is described in more detail in O. E. Rössier, Phys. Lett. 57A, 397-398 (1976).

The Hénon map referred to above has the form:

$$[ \begin{matrix}{x}_{n + 1} \\ {y}_{n + 1}\end{matrix} ] = [ \begin{matrix}1 + {y}_{n} - a {x}_{n}^{2} \\ b {x}_{n}\end{matrix} ]$$

wherein typical parameter values are: a=1.4, b=0.3. For more details, see M. Hénon, Commun. Math. Phys. 50, 69-77 (1976).

A logistic map of the form xₙ₊₁=μxₙ(1−xₙ) may be employed. The Anosov map, often referred to as the cat map having the form:

$$[ \begin{matrix}{x}_{n + 1} \\ {y}_{n + 1}\end{matrix} ] = [ \begin{matrix}1 & 1 \\ 1 & 2\end{matrix} ] [ \begin{matrix}{x}_{n} \\ {y}_{n}\end{matrix} ] mod 1$$

may also be used.

The map is composed of two steps; i) a linear matrix multiplication, ii) a non-linear modulo operation, which forces the iterates to remain within the unit square. It is possible to generalize the Anosov maps to an arbitrary number of variables. Furthermore, the matrix may have arbitrary coefficient only limited by the requirement of being area-preserving and having at least one positive Lyapunov exponent for the system. These exponents can be calculated analytically for such systems. For more details, reference is made to A. J. Lichtenberg and M. A. Lieberman, Regular and Chaotic Dynamics, Springer 1992 (p.305).

Systems of arbitrarily high dimension may be constructed by coupling systems of lower dimensions, referred to as subsystems. The subsystems can be identical or different. They can e.g. be different by using different parameters in the various subsystems, and/or they may be different by employing different equations. The coupling can be a function of one or more of the state variables in the individual subsystems. Several types of coupling exist, including local and global coupling.

Local coupling implies that the individual subsystems are affected through a coupling by some but not all the subsystems in the entire system. Examples of local couplings are unidirectional and bi-directional coupling, which implies that the coupling is a function of one and two subsystems, respectively. By use of these types, map lattices can by constructed. An example of such a system with a local unidirectional copuling is the following N-dimensional system:

x₁→f₁(x₁)+ε₁x_{N},

x₂→f₂(x₂)+ε₂x₁,

•

•

•

x_{N}→f_{N}(x_{N})+ε_{N}x_{N-1},

where f_{1 . . . N} are mathematical functions and ε_{1 . . . N} are coupling constants. The mathematical functions and coupling constants may be different for each subsystem.

A usual choice of local coupling can be the diffusive coupling, referring to a type of coupling proportional to the difference between two subsystems. This can be defined as:

X→f(X)+ε(X−Y),

where X and Y are two subsystems of at least dimension one and ε is a matrix of coupling constants.

The term global coupling refers to situations where all subsystems are coupled to each other, sometimes termed an all-to-all coupling. This can, for instance, be achieved by letting the coupling be a function of the mean field, i.e. the average of all the subsystems. This is defined by:

$$X \to f ( X ) + ϵ \frac{1}{N} {\sum }_{i = 1}^{N} {X}_{i} ,$$

where X is a subsystem of at least dimension one and ε is a coupling constant.

Furthermore, the coupling function can be any linear or non-linear function of the subsystems.

An example of a local bi-directional coupling is given in the following equation:

xᵢ→f(xᵢ)+ε[xᵢ₋₁−(1+γ)xᵢ+γxᵢ₊₁], i∈[1,M]

Another type of local coupling is the unidirectional local coupling, where a given state is coupled to one of its neighbouring states. This can for example be defined as:

xᵢ→f(xᵢ)+εg(xᵢ₋₁), i∈[1,M]

where g is either a linear or non-linear function. For the linear case, the system is simply defined by:

xᵢ→f(xᵢ)+εxᵢ₋₁, i∈[1,M]

Furthermore global coupling can be applied, i.e. each individual system is coupled to all other systems. This could be done in the following way:

xᵢ→f(xᵢ)+εg(x₁, x₂, x₃ . . . x_{M}), i∈[1,M]

where g is a function of all states in the system and g can be a linear or nonlinear function.

Furthermore g can be a linear or nonlinear function of a subset of the M states. Further, a map lattice which is a type of coupled maps may be employed. In the example below, xᵢ denotes a variable on a lattice (represented by an N-dimensional array of points), the lattice being a ID array with M points. Each point on the lattice is updated according to the function on the right hand side of the arrow, where the function f may for example be the logistic map. As is seen, neighbouring points on the lattice couple linearly, where the linear coupling is adjusted by the parameters γ and ε. Boundary conditions refer to the way lattice elements 1 and M are treated.

xᵢ→f(xᵢ)+ε[xᵢ₋₁−(1+γ)xᵢγxᵢ₊ᵢ], i∈[1,M].

Finally, certain simple 3D flow equations may be employed, the systems consist normally of fewer terms than the Lorenz and Rössler systems. That is, either five terms and two nonlinearities or-six terms and one nonlinearity. In comparison the Lorenz and Rössler systems each consist of seven terms, cf. 1. C. Sprott, Phys. Rev. E 50, R647-R650 (1994). Appropriate systems are given in the below list:

dx/dt=y, dy/dt=−x+yz, dz/dt=1−y²

dx/dt=yz, dy/dt=x−y, dz/dt=1−xy

dx/dt=yz, dy/dt=x−y, dz/dt=1−x²

dx/dt=−y, dy/dt=x+z, dz/dt=xz+3y²

dx/dt=yz, dy/dt=x²−y, dz/dt=1−4x

dx/dt=y+z, dy/dt=−x+0.5y, dz/dt=x²−z

dx/dt=0.4x+z, dy/dt=xz−y, dz/dt=−x+y

dx/dt=−y+z², dy/dt=x+0.5y, dz/dt=x−z

dx/dt=−0.2y, dy/dt=x+z, dz/dt=x+y²−z

dx/dt=2z, dy/dt=−2y+z, dz/dt−x+y+y²

dx/dt=xy−z, dy/dt=x−y, dz/dt=x+0.3z

dx/dt=y+3.9z, dy/dt=0.9x²−y, dz/dt=1−x

dx/dt=−z, dy/dt=−x²−y, dz/dt=1.7+1.7x+y

dx/dt=−2y, dy/dt=x+z², dz/dt=1+y−2x

dx/dt=y, dy/dt=x−z, dz/dt=x+xz+2.7y

dx/dt=2.7y+z, dy/dt=−x+y², dz/dt=x+y

dx/dt=−z, dy/dt=x−y, dz/dt=3.1x+y²+0.5z

dx/dt=0.9−y, dy/dt=0.4+z, dz/dt=xy−z

dx/dt=−x−4y, dy/dt=x+z², dz/dt=1+x

A further mathematical system is described below with reference to FIG. 28, cf. the below description of the drawings.

The Lorenz system comprises the following differential equations:

$$\begin{matrix}\frac{ⅆ x}{ⅆ t} = σ ( y - x ) , \\ \frac{ⅆ y}{ⅆ t} = r x - y - x z , \\ \frac{ⅆ z}{ⅆ t} = x y - b z ,\end{matrix}$$

wherein X=(x, y, z) are state variables, t is the independent variable, and σ, r and b are parameters.

In case the following conditions are fulfilled:

$$( σ - b - 1 ) > 0 , r > 1 , r , σ \frac{( σ + b + 3 )}{( σ - b - 1 )} , σ , r , b > 0 ,$$

the stationary points of the Lorenz system are not stable, in which case the Lorenz system is likely to exhibit chaotic behavior. The parameters may be constant or variable, variable parameters contributing, e.g., to the results of the computations being more unpredictable which may be useful in a pseudo-random number generating method or in an encryption/decryption method.

In the case of a non-linear mapping, the computations may comprise numerically iterating the non-linear function, the iteration being based on an initial condition X₀ of the state variable X.

The step of performing computations may comprise numerically integrating the non-linear differential equations by repeatedly computing a solution Xₙ₊₁ based on one or more previous solutions Xₘ, m≦n+1, and a step length, ΔTₙ, of the independent variable, t. Preferably, at least one initial condition, X₀, of the state variable, X, and an initial step length, ΔT₀, are provided. The step length may be given before the computations are initiated, or it may be computed as the computations proceed. For example, the initial step length, ΔT₀, may be computed from the initial condition X₀.

The step length may vary between equations in a system. It may for example differ from one equation to another. The step length vector ΔT is used to represent the step length for each equation in the system. The ΔT vector has the same dimension as the system.

In a discretized formulation of the Lorenz system, the solution X_{n∈}may be computed using the step length ΔT=(Δt_{x,n}, Δt_{y,n}, Δt_{z,n}) as follows:

xₙ₊₁=xₙ+(σ(yₙ−xₙ))·Δt_{x,n}

yₙ₊₁=yₙ+(xₙ(r−zₙ)−yₙ)·Δt_{y,n}

zₙ₊₁=zₙ+(xₙyₙ−bzₙ)·Δt_{z,n},

wherein:

Δt_{x,n} is the step length used in the computation of xₙ₊₁,

Δt_{y,n} is the step length used in the computation of yₙ₊₁,

Δt_{z,n} is the step length used in the computation of zₙ₊₁.

As mentioned above, the step length ΔT may be constant or may vary throughout the computations. For example, in each or in some of the integration steps, at least one of the elements (Δt_{x,n}, Δt_{y,n}, Δt_{z,n}) of the step length ΔT may be a function of one or more numbers involved in or derived from the computations. Also, in each integration step, at least one of the elements (Δt_{x,n}, Δt_{y,n}, Δt_{z,n}) of the step length ΔT may be a function of at least one solution, Xₘ, which is a current or previous solution to the mathematical system. In each or some of the integration steps, at least one of the elements (Δt_{x,n}, Δt_{y,n}, Δt_{z,n}) of the step length ΔT is a function of at least one step length, ΔTₘ, which is a current or previous integration step. The varying step length ΔT may be used in any numerical solution of differential equations, and accordingly —there is disclosed a method of numerically solving differential equations using a variable step length. In a pseudo-random number generating method, such as in an encryption/decryption method, the variable step length may contribute to improving the security of the system, i.e. to make the resulting keystream more unpredictable.

In a pseudo-random number generating method, the initial condition X₀ and/or the initial step length ΔT₀ may be calculated from or represent a seed value. In an encryption/decryption method, at least a part of the initial condition X₀ and/or at least a part of the initial step length ΔT₀ may be calculated from or represent an encryption key. Also, at least a part of at least some of the parameters of the mathematical system may be calculated from or represent a seed value or an encryption key. The key may be a public or a private key.

The extracted set of data may comprise a pseudo-random number which may be used for encryption. A plurality of numbers resulting from the computations may be extracted. The step of extracting may comprise extracting one or more numbers derived from a number, k, of bits of the resulting number, such as the k least significant bits from the resulting number or numbers, which contributes to the unpredictability of the derived number. The k bits extracted may for example be derived by applying a modulus or a logical “and” function to the resulting number or numbers. As an alternative to extracting the k least significant bits, the step of extracting may comprise extracting k bits at predetermined or variable positions in the resulting number. The number k may be an integer value selected from in the range between 8 and 128, such as 16-64, such as 24-32. In case a plurality of numbers are extracted, the extracted numbers may be derived by means of different values of k, which further contributes to the unpredictability of the derived number. The extracted number or numbers may be manipulated by means of arithmetic and/or logical operations, so as to obtain a combined set of data. One or more of the extracted numbers and/or the combined set of data may be combined with original data in an arithmetic and/or logical operation, so as to encrypt the original data. Similarly, one or more of the extracted numbers and/or the combined set of data may be combined with encrypted data in a arithmetic and/or logical operation, so as to decrypt the encrypted data and obtain the original data. The arithmetic and/or logical operation may comprise an XOR operation, multiplication or addition. For example, the arithmetic and/or logical operation may comprise addition of the original data and the combined set of data for encryption, and subtraction of the combined set of data from the encrypted data for decryption. Alternatively, the arithmetic and/or logical operation comprises subtraction of the combined set of data from the original data for encryption, and addition of the combined set of data and the encrypted data for decryption. It may be necessary to apply a modulus function when subtracting or adding numbers. In case the extracted set of data comprises data derived from a plurality of numbers, one set of bits, for example the k least significant bits may be extracted from one number, whereas other bits, for example the 47th-54th bit in a 64-bit number, may be extracted from the other number.

In a block-cipher encryption/decryption system, the computations may involve data representing a block of plaintext, so that the plaintext and a key is entered into, e.g., an encryption system which gives the ciphertext as an output. The extracted set of data may be used to define at least one operation on a block of plaintext in the block-cipher encryption and decryption system. The methods described herein may be applied in a block-cipher algorithm, wherein a block of plaintext is divided into two sub-blocks, and one sub-block is used to influence the other, for example where a modified version of a first block (or a part thereof) is used to influence the other (or a part thereof), e.g., by an XOR function. Such an algorithm is generally referred to as a Feistel Network, cf. Applied Cryptography by Bruce Schneier, Second Edition, John Wiley & Sons, 1996. In such case the first sub-block or the modified version thereof may be transformed by a Hash function relying on the method, the Hash function being given a cryptographic key as an input. In each round, a new cryptographic key may be given as input to the Hash function. Alternatively, the same cryptographic key may be given to the Hash function in all rounds. As a further alternative, the cryptographic key may vary from block to block, for example by giving the same cryptographic key as an input in all rounds for each block, or by giving different cryptographic keys as inputs for each block and for each round.

The extracted data may be used as a decryption or an encryption key. In a system, wherein computations are performed in two mathematical systems, the extracted set of data from one of the systems may be used to generate keys or used as keys for the other system. The extracted data may also be used in generation of data representing a digital signature, and/or in watermarking of digital data.

In the methods described herein, the electronic device may comprise an electronic processing unit having a register width, whereby the method may comprising the steps of:

expressing at least one integer number of a bit width larger than said register width as at least two sub-numbers each having a bit width which is at most equal to said register width,

performing at least one of said computations as a sub-computation on each of the sub-numbers so as to arrive at at least two partial results, expressed as integer numbers of a bit width smaller which is at most equal to the register width of the processing unit,

concatenating the partial results to yield a representation of a result of said at least one computation.

Analogously, computations on numbers of a width smaller than the register width of the processor may also be performed, whereby an operation, for example a logical AND, may be performed, so that the upper half of, e.g., a 64-bit register is not used for computations on 32-bit numbers. In order to maintain the sign of the number in question, the most significant bit of, e.g., the 32-bit number may be copied into the upper 32 bits of the 64-bit register.

The integer numbers usually comprise or represent the fixed-point number or numbers used in the computations. A fixed-point number expressed in terms of an integer type number may represent a real number.

D Detection of Periodic Behavior

A method of detecting periodic behavior in the solution of a mathematical system comprising at least one non-linear function governing at least one state variable with respect to at least one independent variable, comprises:

expressing the mathematical system in discrete terms,

performing computations so as to obtain resulting numbers, the resulting numbers 3 representing at least parts of solutions to the mathematical system,

storing selected solutions in an array, A, in a memory of the electronic device, the array being adapted to store a finite number, n+1, of solutions,

determining whether at least one of:

a current solution, and

a particular one of said solutions stored in the array

is substantially identical to another solution stored in the array. It should be understood that this method constitutes an independent aspect of the present invention.

The steps of performing computations, storing selected solutions, and determining may be performed continuously during the computations, i.e. repetitively during the computations, such as in each computational step, such as in connection with each iteration.

If a current solution or a particular one of the solutions stored in the array is substantially identical to one or more other solutions stored in the array the solution of the mathematical system is likely to show periodic behavior. In case one of the methods described herein is used in a pseudo-random number generating method, in particular if it is used in an encryption/decryption method, such periodic behavior is undesirable, as it negatively influences the unpredictability of the generated pseudo-random numbers or the keystream. By applying the above method, periodic behavior may be detected.

The step of determining whether a current solution or a particular one of the solutions stored in the array is substantially identical to one or more other solutions stored in the array preferably comprises determining whether the solutions are completely identical. When solving a mathematical system expressing an array of state variables X, the step of determining may comprise determining whether only some of the entries of X are substantially identical.

In order to save computational time and/or memory, only selected solutions may be stored in the memory.

In the method, each entry in the array may contain a solution having an age which is growing by array level, Aᵢ, 0≦i≦n, and the method may comprise:

at the step of storing selected solutions in the array: storing a current solution at the 0'th level, A₀, in the array, A, thereby overwriting an old value stored at the O'th level in the array, A,

if a 0'th predetermined criterion is fulfilled: transferring the old value to the 1'st level in the array, A, before the O'th level is overwritten by the current solution, and

for the 1st level and each further level i in the array:

if an i'th predetermined criterion for level i is fulfilled: transferring the old value stored at the i'th level to the 1+1'st level in the array, A, before the i'th level is overwritten by the value transferred from the i−1'st level,

if the n'th level is to be updated: discarding the old value previously stored at the n'th level.

For each level, i, in the array, the number of times an old value stored at the i'th level has been overwritten by a new value without the old value being transferred to the i+1'st level may be counted, the i'th predetermined criterion being fulfilled if the old value has not been transferred for a predetermined number of times. The predetermined number of times may be the same for all levels of the array, A, or it may vary between the levels. The predetermined number of times for the i'th level of the array, A, may for example be dependent on one or more values stored in the array, such as when there occurs a change of sign in one or more of the values.

The step of

determining whether a current solution or a particular one of said solutions stored in the array is substantially identical to one or more other solutions stored in the array

may only be performed when a test criterion is fulfilled. For example, the test criterion may be fulfilled when the sign of at least one state variable changes from +to −, or from − to +, or both. The test criterion may also be fulfilled when there occurs a change of sign of at least one derivative of at least one state variable with respect to at least one independent variable, in which case the method further comprises computing the derivative.

In the method, a test value may be computed from the at least one state variable and/or from the derivative, the test criterion being based on the test value. The test criterion may for example be fulfilled when there occurs a change of sign in the test value or in a derivative of the test value, or predetermined values may be provided.

E Pseudo-Number Generation and Encryption/Decryption

A method of generating a pseudo-random number, comprises:

I) expressing a mathematical system in discrete terms,

II) defining a seed value representing at least an initial condition for the mathematical system,

III) expressing at least one variable of the mathematical system as a fixed-point number,

IV) performing computations including the at least one variable expressed as a fixed-point number and obtaining, from said computations, a resulting number, the resulting number representing at least one of:

a. at least a part of a solution to the mathematical system, and

b. a number usable in further computations involved in the numerical solution of the mathematical system,

V) extracting, as the pseudo-random number, a number derived from at least one number which has occurred during the computations. This method constitutes/an independent aspect of the present invention.

The seed value may be a user-defined value, such as an encryption/decryption key in case the method is applied in an encryption/decryption method.

The pseudo-random number may be extracted as a number derived from the k digits of the one or more numbers which have occurred during the computations, e.g. the k least significant bits or k selected bit from the one or more numbers.

The method may comprise repeating steps IV) and V) until a given amount of pseudo-random numbers has been generated.

A given amount of pseudo-random numbers may be generated and stored in a memory of the electronic device as a spare seed value, which may, e.g., be used if periodic behavior is detected by the above method or by another method. The given amount of pseudo-random numbers may be stored internally in an algorithm.

The method may further comprise a method for detecting periodic behavior as discussed above. In that case the method for generating a pseudo-random number may comprise, if the step of:

determining whether a current solution or a particular one of said solutions stored in the array is substantially identical to one or more other solutions stored in the array

reveals that the current solution or the particular solution is identical to one or more other solutions,

interrupt the pseudo-random-number generation, i.e. interrupting repetition of steps IV) and V),

use the spare seed value as the seed value in the step II),

resume the pseudo-random-number generation, i.e. resuming repetition of steps IV) and V).

Thus, for example, in an encryption/decryption method, a spare encryption/decryption key may be used if periodic behavior is detected.

Prior to the step of resuming the pseudo-random number generation, a given amount of pseudo-random numbers may be generated and stored, in a memory of the electronic device, as a new spare seed value. Each level in the array, A, is preferably reset prior to step IV), when steps IV) and V) are initiated with a new seed value at step II).

A method of encrypting a set of original data into a set of encrypted data, comprises the steps of:

A) generating a pseudo-random number by performing the steps of:

I) expressing a mathematical system in discrete terms,

II) defining an encryption key representing at least an initial condition for the mathematical system,

III) expressing at least one variable of the mathematical system as a fixed-point number,

IV) performing computations including the at least one variable expressed as a fixed-point number and obtaining, from the computations, a resulting number, the resulting number representing at least one of:

a. at least a part of a solution to the mathematical system, and

b. a number usable in further computations involved in the numerical solution of the mathematical system,

V) extracting, as the pseudo-random number, a number derived from at least one number which has occurred during the computations,

B) manipulating the original data and the pseudo-random number by means of at least one of:

i. an arithmetic operation, and

ii. a logical operation,

so as to obtain a combined set of data, the combined set of data being the encrypted data.

Prior to step A), a sub-set of the original data may be separated from the set of data, and step B) may be performed on the sub-set of data. This step may be repeated until a plurality of sub-sets which in common constitute the entire set of original data have been encrypted.

The pseudo-random number may be extracted as a number derived from the k bits of the one or more numbers which have occurred during the computations, e.g. the k least significant bits or k selected bits.

Steps IV) and V) may be repeated until a given amount of pseudo-random numbers has been generated.

A given amount of pseudo-random numbers may be generated and stored in a memory of the electronic device as a spare encryption key. For example, a number resulting from or occurring in at least one integration or iteration step of the computations may be stored as a spare encryption key. The spare encryption key may, e.g., be used if encryption is interrupted due to the occurrence of periodic behavior in the solution to the mathematical system. In case no output of the spare encryption key is needed, it may be stored internally in an encryption algorithm. When the method is used for decryption, the spare key is a decryption key.

As it appears from the above, the method may comprise a method for detecting periodic behavior, in which case the method for encrypting may comprise, if the step of

determining whether a current solution or a particular one of said solutions stored in the array is substantially identical to one or more other solutions stored in the array

reveals that the current solution or the particular solution is identical to one or more other solutions,

interrupt the pseudo-random number generation, i.e. interrupting repetition of steps IV) and V),

use the spare encryption key as the encryption key in step II),

resume the pseudo-random number generation, i.e. resuming repetition of steps IV) and V).

Prior to the step of resuming the pseudo-random number generation, a given amount of pseudo-random numbers may be generated and stored in a memory of the electronic device as a new spare encryption key.

Preferably, each level in the array, A, is reset prior to step IV), when steps IV) and V) are initiated with a new seed value at step II).

A method of decrypting a set of encrypted data which has been encrypted by the method discussed above, comprises the steps of:

a) performing step A) as defined above in connection with the encryption method, so as to extract the same pseudo-random number as extracted in step V) of the encryption method,

b) manipulating the encrypted data and the pseudo-random number by means of arithmetic and/or logical operations, so as to obtain the original, i.e. decrypted, version of the data.

Prior to step a), a sub-set of the encrypted data may be separated from the set of encrypted data, and in case the sub-set of data has been encrypted by the above encryption method, the method of decrypting may comprise performing steps a) and b) on the sub-set of data. This step may be repeated until a plurality of sub-sets which in common constitute the entire set of encrypted data have been decrypted.

Any of the steps of the encryption method may be applied in an identical manner when decrypting the encrypted data as during the previous sequence of encrypting the original data.

F Processing in a Plurality of Instances in Parallel

A method of generating a pseudo-random number, comprises, in one instance:

I) expressing a mathematical system in discrete terms,

II) defining a seed value representing at least an initial condition for the mathematical system,

III) expressing at least one variable of the mathematical system as a fixed-point number,

IV) performing computations including the at least one variable expressed as a fixed-point number and obtaining a resulting number, the resulting number representing at least one of:

a. a part of a solution to the mathematical system, and

b. a number usable in further computations involved in the numerical solution of the mathematical system,

V) extracting, as the pseudo-random number, a number derived from at least one number which has occurred during the computations,

performing steps I)-V) in a plurality of instances in parallel. This method constitutes an independent aspect of the present invention.

Computations in the two or more instances may be performed either at the same time, or successively. Thus, the computations in the two or more instances may be performed by executing instructions which process a plurality of computations at the same time, or by executing instructions which only process a single computation at a time.

Thus, pseudo-random number generation in a plurality of instances in parallel may, in some cases, be faster than if the steps are performed in one instance only, in particular if the hardware on which the method is executed supports parallel processing. Further, by coupling the two or more instances, a larger key length in encryption may be applied than if only one instance were used. For example, one part of an encryption key may be used for a first instance, and another part of the encryption key may be used for a second instance.

Mathematical systems of arbitrarily high dimension may be constructed by coupling systems of lower dimension, referred to as subsystems. For example, N logistic maps can be coupled, yielding an N-dimensional system. The coupling mechanism can be engineered by including either linear or non-linear coupling functions in the N different maps corresponding to the N different variables. The coupling function in the map governing one variable may or may not depend on all other variables. Alternatively, the coupling can be carried out by substituting one of the N variables into one or more of the N−1 remaining maps.

Two or more logistic maps may be coupled through linear coupling terms. In the example shown below, the parameters ε₁ and ε₂ in front of the coupling terms control the strength of the coupling, i.e. the degree of impact that each one of the two logistic maps has on the other one.

$$[ \begin{matrix}{x}_{n + 1} \\ {y}_{n + 1}\end{matrix} ] = [ \begin{matrix}{λ}_{1} {x}_{n} ( 1 - {x}_{n} ) + {ϵ}_{1} ( {y}_{n} - {x}_{n} ) \\ {λ}_{2} {y}_{n} ( 1 - {y}_{n} ) + {ϵ}_{2} ( {x}_{n} - {y}_{n} )\end{matrix} ]$$

Numbers or data may be transmitted between the plurality of instances at least while performing step IV) for each of the instances. The same applies to step V).

The method may comprise combining, by use of arithmetic and/or logical operations, a plurality of pseudo-random numbers extracted at step V) in each of the instances into a common pseudo-random number.

Parameter and/or variable values, or parts thereof, may be exchanged between the two instances. Thus, for example xₙ₊₁ of one instance and xₙ₊₁ of another instance may be exchanged after each iteration step, or xₙ₊₁ of one instance may be exchanged with yₙ₊₁ of another instance. Likewise, the step length Δtₙ may be exchanged between the two instances. The exchange of variable or parameter values may also be achieved by performing logical and/or arithmetic operations on a value of a first instance before using that value for modifying a value of a second instance.

G Using a Cryptographic Key as an Input to a Mathematical System

A method of performing numerical computations in a mathematical system comprising at least one function, may comprises the steps of:

expressing the mathematical system in discrete terms,

expressing at least one variable of the mathematical system as a fixed-point number,

performing said computations in such a way that the computations include the at least one variable expressed as a fixed-point number,

obtaining, from said computations, a resulting number, the resulting number representing at least one of:

a. at least a part of a solution to the mathematical system, and

b. a number usable in further computations involved in the numerical solution of the mathematical system,

the step of performing computations comprising:

repeatedly computing a solution Xₙ₊₁ based on at least one previous solutions Xₘ, m≦n+1, whereby the step of performing computations is initiated based on at least one initial condition, X₀, of the state variable, X,

the method further comprising:

providing a cryptographic key as an input to said computations, whereby the cryptographic key is used in generation of the initial condition X₀. This method constitutes an independent aspect of the present invention.

It should be understood, that, in the present context, the term “previous solutions” also covers the current solution, Xₙ₊₁.

The cryptographic key may further be used for initializing parameters of the mathematical system.

H Generation of an Identification Value for Identifying or Proving the Identity of a Set of Data

A method of determining an identification value for identifying a set of data, comprises performing numerical computations in a mathematical system comprising at least one function, the method comprising the steps of:

expressing the mathematical system in discrete terms,

expressing at least one variable of the mathematical system as a fixed-point number,

performing said computations in such a way that the computations include the at least one variable expressed as a fixed-point number,

obtaining, from said computations, a resulting number, the resulting number representing at least one of:

a. at least a part of a solution to the mathematical system, and

b. a number usable in further computations involved in the numerical solution of the mathematical system,

whereby a representation of at least part of the set of data is used in said computations, the method further comprising:

extracting, as said identification value, at least a part of said resulting number. This method constitutes an independent aspect of the present invention.

Thus, the above method may be regarded a Hash function or Hash algorithm which have been discussed in detail above. The identification value may be constituted by a number of extracted numbers which have been extracted at different computational stages in the numerical computations. Extraction may occur at each computational step or at each iteration step, or it may occur only at selected computational stages.

The term “identification value” may be a hash value or a cryptographic check-sum which identifies the set of data, cf. for example Applied Cryptography by Bruce Schneier, Second Edition, John Wiley & Sons, 1996. In case a cryptographic key is used as a seed value for the computations, the hash function is usually referred to as a MAC function (Message Authentication Code).

The mathematical system may comprise a differential equation, such as a partial differential equation or an ordinary differential equation, or a discrete mapping, such as an area-preserving map or a non area-preserving map. The mathematical system may comprise at least one non-linear mapping function governing at least one state variable X.

A non-linear mapping function may for example comprise a logistic map of the form xₙ₊₁=λxₙ(1−xₙ), wherein λ is a parameter, xₙ₊₁ is the value of state variable x at the (n+1)'th stage in the computations, and xₙ is the value of state variable x at the n'th stage in the computations.

The logistic map may be modified into the form xₙ₊₁=λxₙ(1−xₙ)+ε(xₙ−mₙ), wherein λ and ε are parameters, xₙ₊₁ is the value of state variable x at the (n+1)'th stage in the computations, xₙ is the value of state variable x at the n'th stage in the computations, and mₙ contains a representation of an n'th portion of the set of data.

A cryptographic key may be used for at least partially determining at least one of the following: λ, ε and an initial value x₀ of state variable x.

The mathematical system may comprise a set of non-linear mapping functions, such as:

an Anosov map of the form;

$$[ \begin{matrix}{x}_{n + 1} \\ {y}_{n + 1}\end{matrix} ] = [ \begin{matrix}1 & 1 \\ 1 & 2\end{matrix} ] [ \begin{matrix}{x}_{n} \\ {y}_{n}\end{matrix} ] mod 1 , or$$

a Hénon map of the form:

$$[ \begin{matrix}{x}_{n + 1} \\ {y}_{n + 1}\end{matrix} ] = [ \begin{matrix}1 + {y}_{n} - a {x}_{n}^{2} \\ b {x}_{n}\end{matrix} ] .$$

The mathematical system may comprise at least one non-linear differential equation and/or a set of non-linear differential equations.

Preferably, the mathematical system has at least one positive Lyapunov exponent, whereby a certain degree of irregular or chaotic behavior is achieved, whereby randomness properties of the system and security are enhanced.

At least one Lyapunov exponent may be computed at least once during the mathematical computations in order to determine whether the mathematical system exhibits chaotic behavior. If this is not the case, e.g. if the computed Lyapunov exponent is not positive, the computations may be interrupted and resumed from other initial values and/or other parameters.

The at least non-linear differential equation preferably governs at least one state variable, X, which is a function of at least one independent variable, t. The set of non-linear differential equations may for example comprise a Lorenz system.

I Handling of Overflow, Deliberate Generation of Overflow

A method of performing numerical computations in a mathematical system comprising at least one function, comprises the steps of:

expressing the mathematical system in discrete terms,

restricting the range of at least a selected variable of said function, the range being sufficiently narrow so as to exclude values which the selected variable, by virtue of said function, would assume if not restricted by said range,

performing computations so as to obtain a resulting number, the resulting number representing at least one of:

a. a part of a solution to the mathematical system, and

b. a number usable in further computations involved in the numerical solution of the mathematical system,

when the computations result in a value for the selected variable which is beyond the range, assigning a value within the range to the selected variable. This method constitutes an independent aspect of the present invention.

For example, if the upper bits of the value, which is beyond the range, are truncated, the step of assigning a value within the range may be seen as a modulus function. The steps of the method may thus provide deliberate overflow, e.g. in order to enhance randomness properties of an encryption/decryption system and/or in order to make it more difficult to derive information about internal states of the mathematical system from encrypted data.

The above method may thus be a part of a pseudo-random number generating method which, e.g., generates pseudo-random numbers for use in at least one of encryption and decryption. The mathematical system preferably has at least one positive Lyapunov exponent.

K Handling of Imaginary or Virtual Decimal Separator

A further method of performing numerical computations in a mathematical system comprising at least one function, comprises:

expressing the mathematical system in discrete terms,

expressing at least one variable of the mathematical system as an integer number,

placing an imaginary decimal separator in said integer number, whereby the integer number represents a real number,

performing computations including the at least one variable expressed as an integer number so as to obtain a resulting number, the resulting number being expressed as an integer number,

positioning the imaginary decimal separator in the resulting number at a predetermined position by performing at least one of the steps of:

correcting the position of the imaginary decimal separator in the integer number, and

placing an imaginary separator in the resulting number.

This method constitutes an independent aspect of the present invention.

The resulting number is usually a fixed-point number having a fixed position of the decimal separator. Alternatively, the position of the decimal separator in the resulting number may be corrected after the computation has been completed. A third possibility is to correct the position of the decimal separator before and after performing the computation. This may be relevant if not all positions to the left of the decimal separator in the resulting number are used, and it is desired to maintain a relatively higher resolution in the computations than the resolution of the resulting number. For example, the resulting number is desired to have a S(10.21) format. Thus, the addition of, say, two S(7.24) format numbers may be performed in a S(8.23) format which then is converted to the S(10.21) format resulting number. Thereby, the carry from the second and third least significant bits in the arguments may influence the result.

Finally, for some computations no correction of the position of any decimal separator may be required or needed.

The correction of the position of a decimal separator are usually performed by means of shift operations.

In a most general form, a method of performing numerical computations in a mathematical system comprising at least one function, comprises the steps of:

expressing the mathematical system in discrete terms,

expressing at least one variable of the mathematical system as a fixed-point number,

performing said computations in such a way that the computations include the at least one variable expressed as a fixed-point number,

obtaining, from said computations, a resulting number, the resulting number representing at least one of:

a. at least a part of a solution to the mathematical system, and

b. a number usable in further computations involved in the numerical solution of the mathematical system.

L Substitute Computations Requiring No Positioning of an Imaginary Decimal Separator

There is further disclosed, as an independent aspect of the present invention, a circuit for performing numerical computations in a non-linear mathematical system comprising at least one function, the circuit being designed or programmed so that the mathematical system, in the circuit or in the computer program code, is represented in modified terms in such a way that at least a selected one of the numerical computations involves an integer operation, whereby said selected numerical computation in a non-modified representation of the mathematical system would require one or more floating point operations or controlling the positioning of a decimal separator in one or more fixed-point numbers, the circuit being designed or programmed so that said selected computation is substituted by at least one substitute computation on one or more integer numbers, whereby the mathematical system, in the circuit or in the computer program code, is represented in such a way that the at least one substitute computation requires no positioning of an imaginary decimal separator.

The mathematical system may exhibit chaotic behavior.

Thus, for example, the computations:

xₙ₊₁=xₙ+yₙ and

yₙ₊₁=xₙ+2yₙ

may be performed by first computing Xₙ₊₁. Then, the expression for yₙ₊₁ may be computed as:

yₙ₊₁=xₙ₊₁+yₙ

whereby the computational step of multiplying yₙ by 2 may be omitted.

Thus, by performing the substitute computations, computational time may be saved.

Likewise, there is disclosed a method of, in an electronic circuit, performing numerical computations in a non-linear mathematical system comprising at least one function, the method comprising, in the circuit or in a computer program segment according to which the circuit operates, the steps of:

representing the mathematical system in modified terms in such a way that at least a selected one of the numerical computations involves an integer operation, whereby said selected numerical computation in a non-modified representation of the mathematical system would require one or more floating point operations or controlling the positioning of a decimal separator in one or more fixed-point numbers,

substituting said selected computation by at least one substitute computation on one or more integer numbers, whereby the mathematical system, in the circuit or in the computer program code, is represented in such a way that the at least one substitute computation requires no positioning of an imaginary decimal separator,

performing said substitute computation.

### BRIEF DESCRIPTION OF THE DRAWINGS

The above methods will now be further described with reference to the drawings, in which:

FIG. 1 is an illustration of a cryptographic method employing a squaring function of a state variable x,

FIG. 2 is an illustration of a next-state function including a counter increment,

FIG. 3 is an illustration of the system of FIG. 1 with coupling,

FIG. 4 is an illustration of a system with counter incrementation,

FIG. 5 is an illustration of an encryption/decryption process,

FIG. 6 is an illustration of a sequence for encrypting, transmitting and decrypting electronic data,

FIG. 7 is an illustration of an encryption sequence in a block cipher system,

FIG. 8 is an illustration of an encryption sequence in a stream cipher system,

FIG. 9 is an illustration of the key elements in an encryption/decryption algorithm,

FIG. 10 is a plot of a numerical solution to a Lorenz system,

FIG. 11 is an illustration of key extension by padding,

FIG. 12 illustrates a possible method of simultaneously computing two or more instances of identical or different chaotic systems,

FIG. 13 illustrates the principle of performing a check for periodic solutions,

FIG. 14 shows a mathematical system with a periodic solution,

FIG. 15 illustrates transport between levels in the coordinate cache which stores previously calculated coordinates,

FIGS. 16-18 illustrate various criteria for the detection of periodic solutions,

FIG. 19 contains an illustration of a method for multiplication of 16-bit numbers on an 8-bit processor,

FIGS. 20-27 are flow charts showing the operation of one embodiment of an encryption method,

FIG. 28 is an illustration of a mathematical system which may be employed in the methods of the present invention.

### DETAILED DESCRIPTION OF THE DRAWINGS

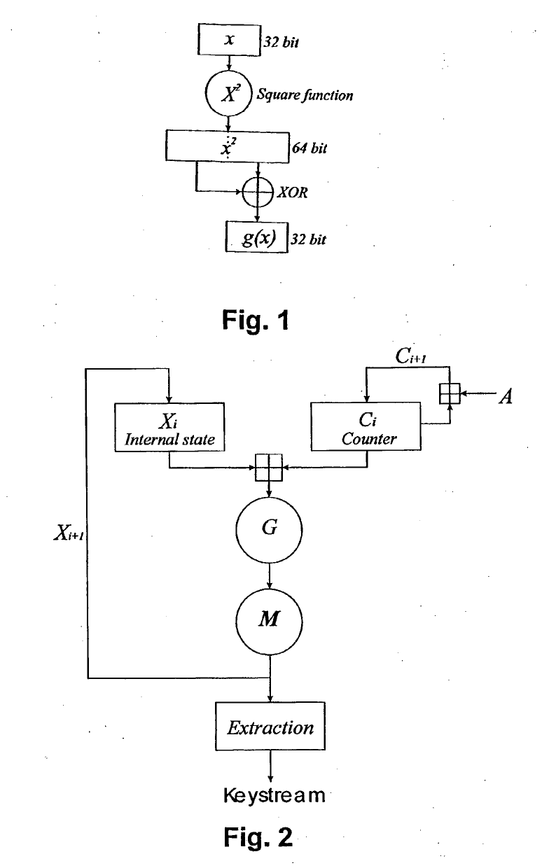

FIGS. 1-5 illustrate various aspects and embodiments of the methods of the invention. As discussed above, stream ciphers produce a stream of pseudo-random bits specified by a key. This stream of bits is referred to as the keystream, and encryption is performed by bitwise XOR'ing a plaintext with the keystream to obtain the ciphertext. The resulting ciphertext is decrypted by reproducing the same keystream specified by the same key and XOR'ing the ciphertext with this keystream to obtain the plaintext.

In order to generate a keystream, an embodiment of a Pseudo Random Number Generator (PRNG) may be built upon 512 internal bits divided between eight 32-bit state variables and eight corresponding 32-bit counter variables, which are incremented and added to the state variables at each iteration. The PRNG works by iterating a system of eight coupled equations based on a non-linear function and extracting 128 bits from the eight state variables after each iteration.

The algorithm is initialized by expanding the 128-bit key into 512 bits which are used to setup both the eight state variables and the eight counter values. The system, defined by the next-state function shown in FIG. 1, is then iterated four times in order to diminish correlation between the state variables and the key. Finally, the counter values are modified by XOR'ing them with the state variables in order to obtain the initial counter value.

A function, in the following referred to as the “g-function” may be employed, the g-function squaring a 32-bit number resulting in a 64-bit number, from which the upper 32-bits and the lower 32-bits are XOR'ed, cf. FIG. 1.

The g-function is used in the system of eight coupled equations, the system being iterated once in order to generate a new state from which 128-bits of random data are extracted. Before each iteration the counter values are incremented according to the counter system described below, and then the new state values are calculated by iterating the following system, cf. also FIG. 2 illustration a system with counter incrementation:

\vec{X}ᵢ₊₁=M×\vec{G}(\vec{X}ᵢ+\vec{C}ᵢ)

Where \vec{X}ᵢ=(x_{0,i}, x_{1,i}, . . . , x_{7,i}), with x_{j,i} being the value of state j at iteration i,

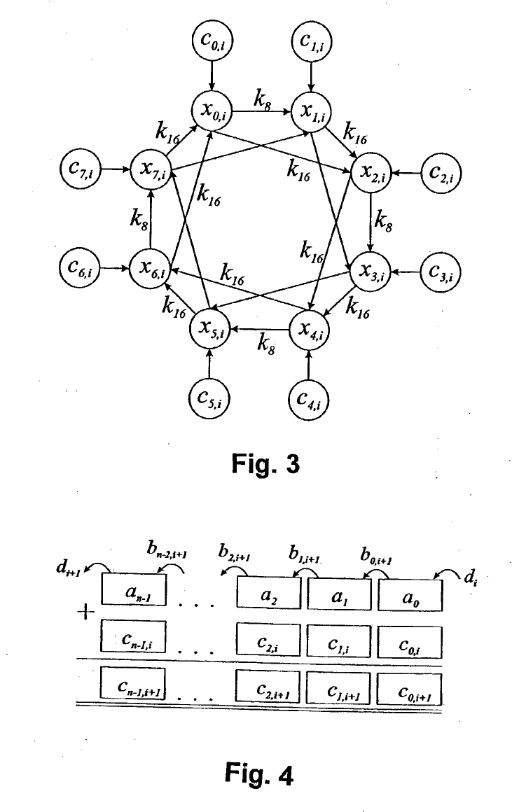

\vec{C}ᵢ=(c₀,c_{1,i}, . . . , c_{7,i}), where c_{j,i} is the value of counter j at iteration i, \vec{G}(\vec{X}) being the g-function evaluated on \vec{X}, i.e. \vec{G}(\vec{X})=(g(x_{0,i}), g(x_{1,i}), . . . , g(x_{7,i})) and M being a coupling matrix defined by:

$$M = ( \begin{matrix}1 & 0 & 0 & 0 & 0 & 0 & {k}_{16} & {k}_{16} \\ {k}_{8} & 1 & 0 & 0 & 0 & 0 & 0 & 1 \\ {k}_{16} & {k}_{16} & 1 & 0 & 0 & 0 & 0 & 0 \\ 0 & 1 & {k}_{8} & 1 & 0 & 0 & 0 & 0 \\ 0 & 0 & {k}_{16} & {k}_{16} & 1 & 0 & 0 & 0 \\ 0 & 0 & 0 & 1 & {k}_{8} & 1 & 0 & 0 \\ 0 & 0 & 0 & 0 & {k}_{16} & {k}_{16} & 1 & 0 \\ 0 & 0 & 0 & 0 & 0 & 1 & {k}_{8} & 1\end{matrix} )$$

where k₈ and k₁₆ imply that the coupling includes permutations of the 32-bits, i.e. for a permutation k, the expression k×g(xᵢ) implies that some or all bits in the number g(xᵢ) are mixed. k₈ indicates that the permutation in question is a 8-bit left rotation, and k₁₆ likewise indicates a 16-bit left rotation. FIG. 3 illustrates such a coupled system.

The dynamics of the counter is defined by \vec{C}ᵢ₊₁=\vec{A}+\vec{C}ᵢ. If a carry occurs, it is saved and added at next iteration step. \vec{A}=(a₀, a₁, . . . , a₇) may for example be a 256 bit constant integer partitioned into eight 32-bit integers. FIG. 4 illustrates the counter incrementation.

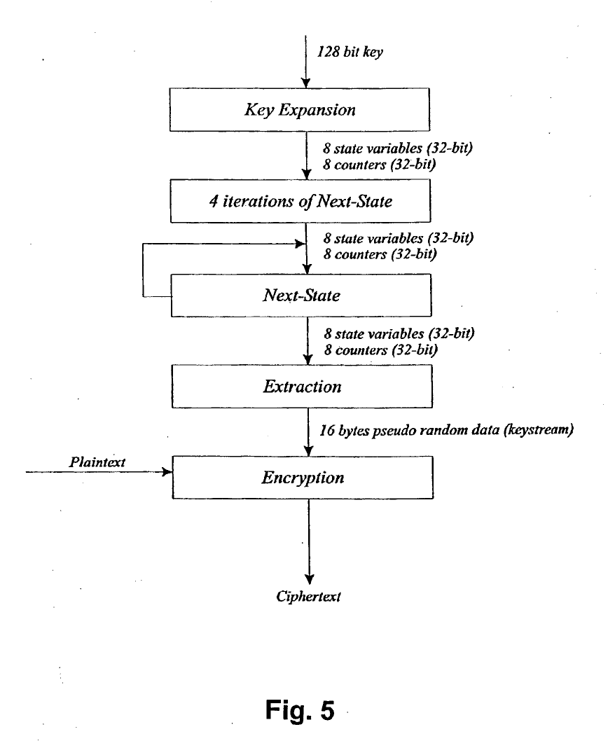

After each iteration step, 128 bits of keystream are extracted by XOR'ing different state variables. For example, the upper 16 bits and the lower 16-bits from two different state variables may be XOR'ed creating a total of eight 16 bit combinations resulting in 128-bits of random data. The keystream is XOR'ed with the plaintext/ciphertext to encrypt/decrypt. FIG. 5 illustrates such an encryption/decryption process.

Many practical applications of pseudo-random number generators require the use of a so-called Initialization Vector (IV). For instance, when large amounts of data are encrypted/decrypted it is necessary to start from one end of the data and continue through all the data. If only a part of the data is to be decrypted, which is towards the end of the data, it is necessary to iterate the appropriate number of times from the beginning of the data to arrive at the output corresponding to the data to be decrypted, which requires a number of computations which are of no direct use and which are time-consuming. This problem can be solved by use of an IV. An IV is also useful in a Virtual Private Network (VPN). In such a network, the data may be divided into packages, and a unique IV is transmitted along with each package, whereby each package can be decrypted individually, even if other packages are lost. The data to be encrypted/decrypted is divided into sections, and each section is associated with a unique IV. The cipher is firstly setup by use of the key, and thereafter the internal state of the mathematical system is changed in an unpredictably way, as function of the IV. These changes may be performed on counters, on the state values or on both. The output of the cipher is then a function of both the key and the IV, and thereby a given section or package can be encrypted/decrypted, without iterating multiple times.

In one example of a method employing an IV, a master state of the mathematical system is created by a usual setup procedure, and subsequently a counter state is manipulated as follows: the 64-bit IV is expanded to 256-bits and XOR'ed on the counter values, and the system is then iterated a number of times to make all bits in the state dependent on all bits in the IV.

The algorithm discussed above is further elaborated in M. Boesgaard, M. Vesterager, T. Pedersen, J. Christiansen and O. Scavenius: Rabbit: A New High-Performance Stream Cipher, Proceedings of Fast Software Encryption (FSE) 2003, Springer, Berlin, (2003).

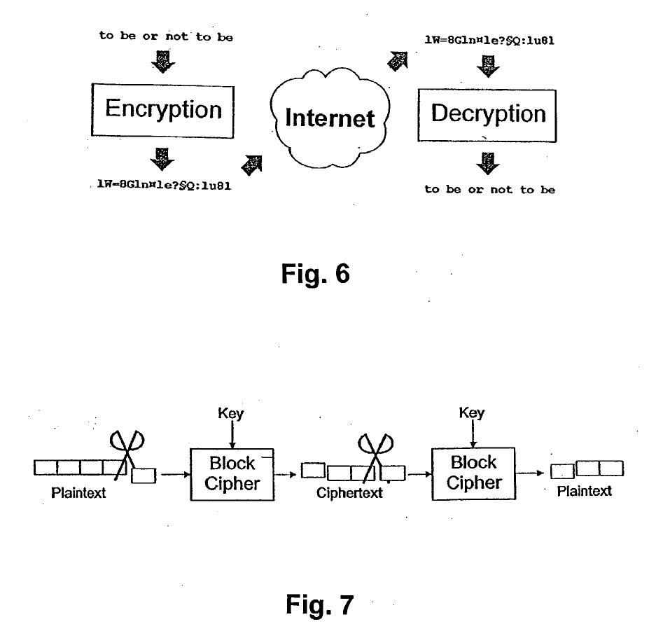

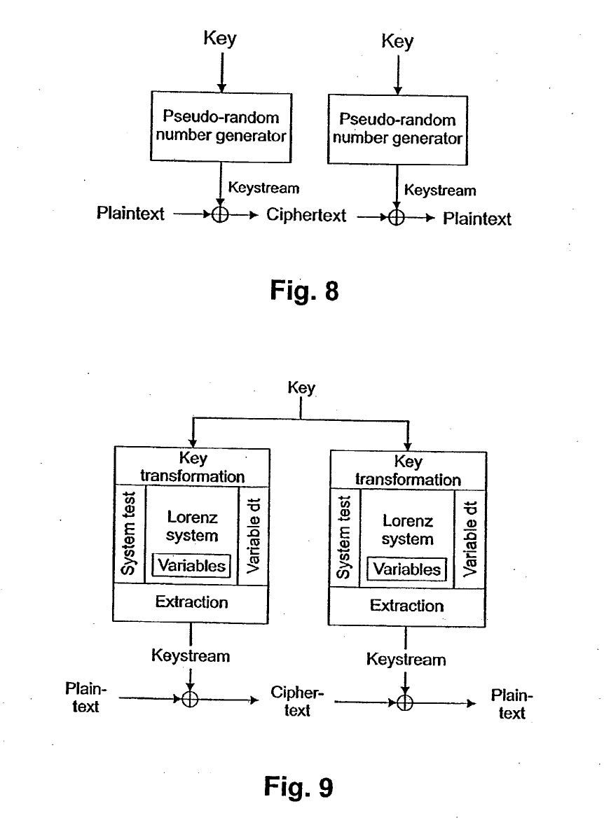

FIG. 6 is a general illustration of a sequence for encrypting, transmitting and decrypting digital data. FIG. 7 is an illustration of an encryption sequence in a block cipher system, and FIG. 8 is an illustration of an encryption sequence in a stream cipher system, block cipher and stream cipher systems being discussed in the above discussion of the background of the invention.

A method and algorithm for encrypting/decrypting data will now be described. The algorithm is applicable for most purposes in data encryption/decryption. However, the nature of the algorithm favours encryption of data streams or other continuous data, such as large files, live or pre-recorded audio/video, copyrighted material (e.g. computer games or other software) and data for storage (e.g. backup and/or transportation). Furthermore, the speed of the algorithm makes it particularly suitable for these purposes. Because of the calculation method, the algorithm is also useable on very small processors.

The algorithm relies on a Pseudo-Random Sequence Stream Cipher system (PRSSC). PSSRC systems are characterized by a pseudo-random number generator (the content of the outer boxes on FIG. 9), which generates a sequence of data, which is pseudo-random, based on a binary key. This sequence, the so-called keystream, cf. FIG. 9, is used for the encryption and decryption. The keystream is unique for each possible key.

Applying the logical XOR-function (stated in the figure by the ⊕-symbol) on the plaintext and an equal amount of keystream encrypts the plaintext. The output of the XOR-function is the ciphertext. Applying the same approach once more on the ciphertext decrypts it into plaintext. The decryption will only reveal the encrypted plaintext if the key used for the decryption is fully identical to the key used for the encryption.

The integrity of the encrypted data is lying in the key capable of decrypting the ciphertext. Therefore it must be difficult to guess the key. To ensure this, the basic design of the algorithm is using a key of at least 128 bit. A key-size of 128 bit gives approximately 3.4.1038 different keys.

The algorithm uses a system, which exhibits chaotic behaviour, such as a Lorenz system, which consists of the following three ordinary differential equations:

$$\begin{matrix}\frac{ⅆ x}{ⅆ t} = σ ( y - x ) \\ \frac{ⅆ y}{ⅆ t} = rx - y - xz \\ \frac{ⅆ z}{ⅆ t} = xy - bz\end{matrix}$$

where σ, r, b are parameters, and x, y, z are state variables.

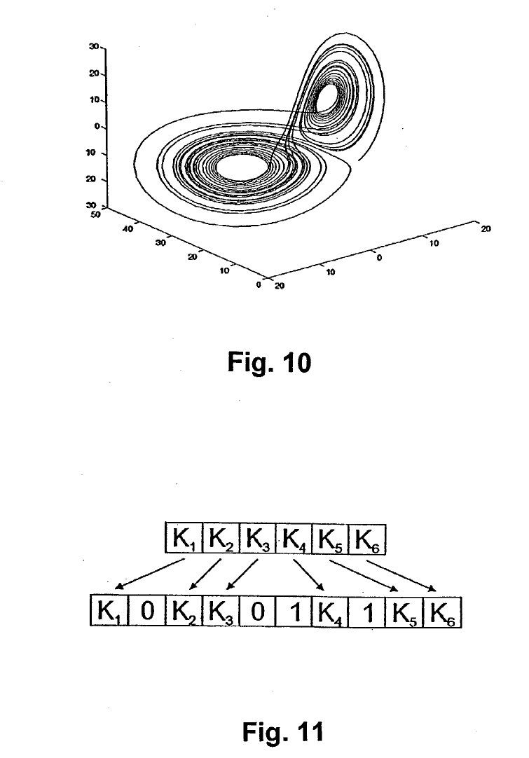

FIG. 10 shows a plot of a numerical solution to a Lorenz system.

The following parameter criteria should be satisfied for chaos to occur in the system:

$$( σ - b - 1 ) > 0 , \qquad r > 1 , \qquad r > σ \frac{( σ + b + 3 )}{( σ - b - 1 )} , \qquad σ , r , b > 0$$

Even then, not all solutions will be chaotic. In the parameter space, there will be so called periodic windows, referring to combinations of parameters, which give rise to periodic solutions. Before implementing the system, analysis of the parameter-space will be performed using calculation of a Lyapunov exponent. Generally, a positive Lyapunov exponent indicates that the solution to the mathematical system is chaotic, cf. Edward Ott, Chaos in Dynamical Systems, Cambridge University Press 1993.

The parameters are typically determined from a seed value, such as an encryption key or a part of an encryption key. Preferably, algorithms embodying the method of the present invention are designed so that only parameter values within predefined intervals are made possible, whereby it is ensured that the probability of the system having a positive Lyapunov exponent is high. Accordingly, the mathematical system will have a high probability of exhibiting chaotic behavior. The Lyapunov exponent may additionally or alternatively be determined at the beginning or during the mathematical computations, so as to be able to detect non-chaotic behavior of the solution to the mathematical system.

The mathematical system could as well be another continuous system (such as the Rössler system) or a discrete map (such as the Hénon map).

The integration is performed using a numerical integration routine. Provided an initial condition and an integration step length, the numerical integration routine calculates the solution at discrete mesh points, e.g. by using the Euler method or a Runge-Kutta method. Using the Euler method to express the Lorenz equations in discrete terms, the solution can be computed from the following equations

xₙ₊₁=xₙ+(σ(yₙ−xₙ))·Δtₓ

yₙ₊₁=yₙ+(xₙ(r−zₙ)−yₙ)·Δt_{y}

zₙ₊₁=zₙ+(xₙyₙ−bzₙ)·Δt_{z}

The calculations are performed using fixed-point numbers which are described below.

During numerical integration of a system of differential equations, the continuous non-dependent variables (such as time t or space s) are discretized. This process refers to replacing the continuous interval [a;b] with a set of discrete points. In such a system, ΔT=(Δtₓ, Δt_{y}, Δt_{z}) is usually referred to as the step length of the integration or the integration step.

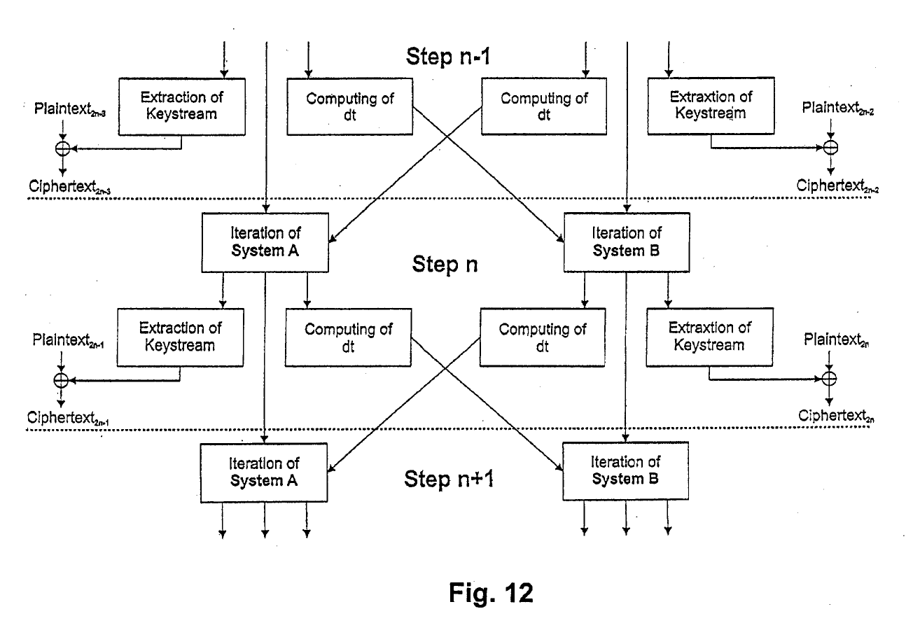

FIG. 12 illustrates a possible method of simultaneously computing two or more instances of the same system or different systems, such as chaotic systems. The method confers higher computational speed and improved security, and a larger key may be used. Preferably there should be some kind of communication or coupling between the two systems, like for example exchange of step length, such as exchange of Δtₓ, Δt_{y}, and/or Δt_{z}.

The internal variables are in the basic design 32 bits wide each, but any variable width could be used. When using the Lorenz system, there are 6 Internal variables (3 state variables and 3 parameters). Thus, 192 bits (in the basic design) are used to represent an internal state of the generator given by a set of the internal variables. The padding of the 128 bits key up to 192 bits should be done in such a way as to avoid illegal values, i.e. to ensure that all variables contain allowed values, and as to avoid that bits from the key are ignored. The padding may include inserting predetermined values of zeros and ones or repetitions of bits from the key. FIG. 11 contains an illustration of key extension by padding.

The integration may be performed with variable time steps, which e.g. can be calculated from any one of the state variables. In the basic design, the step length Δt varies in each integration step. This variation is coupled to the state variable X.

The keystream is extracted from some of the data related to the state variables. This may be done by extracting the 8 least significant bits from the y variable or by collecting some of the data wiped out in the calculations; e.g. from one or more of the multiplications performed in the calculation of one step.

Usually, calculations on a chaotic system are performed on computers using floating-point variables. However, this method introduces problems. One problem is that the use of floating-point variables may cause generation of different keystreams on different computers even if the same key is used, because of the slight differences in the implementation of floating-points on different computer systems.

Therefore fixed-point variables are used. The fixed-point variable is based on the integer data type; which is implemented identically on various computer systems. To express numbers, such as real numbers, digits after the decimal point are needed, the decimal point being artificially located somewhere else than at the end of the number (e.g. 12.345 instead of 12345).

To ensure proper operation of the algorithm, some tests should preferably be performed. Some of these tests are performed at run-time, and others are performed at design-time.

As a part of the initialization process, an amount of keystream equal to the complete data content of the state variables (e.g. 192 bits) or equal to the amount of a complete key (e.g. 128 bits) are generated using the algorithm and saved, in case the key has to be reloaded due to detection of periodic solutions or stationary points. In that case, the saved sequence is loaded as a new key, and the initialization, including extraction of extra key, is redone.

Do to the finite representation of numbers on a computer, any numerical solution will be periodic. However, some keys may result in keystreams having a rather small period. This is undesirable as it may compromise the security of the system. Therefore the there is propsed an algorithm for detecting such periodic solutions. This algorithm watches the sign of a variable or the slope of a variable. When using the Lorenz system, the check is performed on x. When the sign changes from minus to plus (or plus to minus or just alters) the position check is performed (the position check can also be performed after all iterations). The position check compares the complete set of state variables with buffered sets from earlier. If a complete match is found, a periodic solution is detected.

Stationary points of a dynamical system are sets of state variables which remain unchanged during iteration. Such stationary points may be detected by comparing the current set of state variables with the last set, or by checking if the slopes of all of the variables are zero or by checking if both the current slope of one variable and its previous slope are zero. Chaotic systems may, for one reason or another, enter into periodic solutions. This has to be detected and corrected in order not to compromise the security of the system. If the solution of the system becomes periodic, encryption may preferably be stopped, as the extracted number from the solution of the mathematical system will also be periodic and hence not pseudo-random. The test for periodic solutions includes comparing coordinates of the solution with previously calculated coordinates. If a complete match is found, the system has entered a periodic solution.

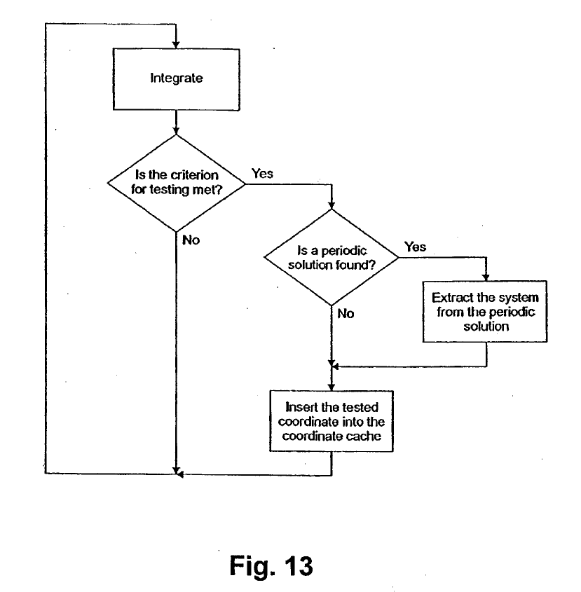

To reduce the amount of memory required to store previously calculated coordinates, and to reduce the processing time required to test the coordinates, only selected coordinates are stored in the coordinate cache. To reduce the processor time required to test for periodic solutions, the test is only performed when the coordinates meet certain criteria. FIG. 13 illustrates the principle of performing a check for periodic solutions.

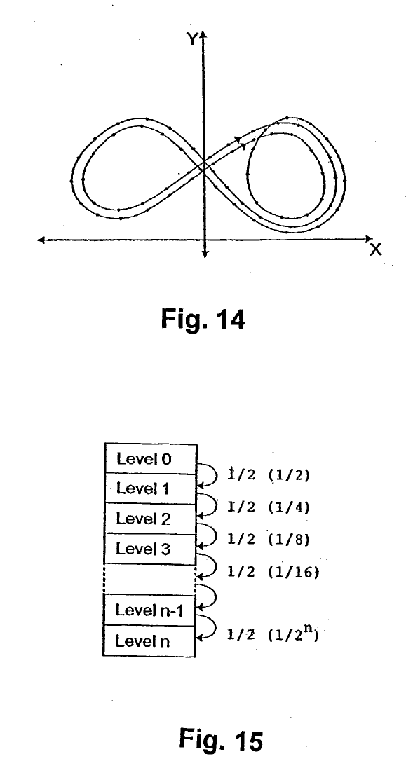

FIG. 14 shows a mathematical system with a period solution, more specifically a two-dimensional non-linear system with a periodic solution. The system is deterministic meaning that the solution is completely specified by its initial conditions. In theory, the solution will be continuous, thereby consisting of infinite many points. When solving the system numerically, the time-interval is discretized, and the solution is calculated at these points. The numerical solution to a mathematical system is simply a sequence of coordinate sets. If we consider a two-dimensional system, then the solution is specified at a number of points (x,y), illustrated by dots on the curve in FIG. 14. The deterministic nature of the system implies that if the solution ever hits a point, which it has visited previously, the solution is periodic and will keep being periodic. This property is employed in the present test.

In order to test for periodic solutions during numerical integration, we have to compare the present calculated coordinate set with the previous values. In order to do this, the coordinate sets are stored as they are calculated. This storage works like a queue and is referred to as the coordinate cache. A calculated coordinate set is compared to every coordinate set in the coordinate cache. If a complete match (all values in the two coordinate sets are equal) is found, the system is in a periodic state. If the test is passed without a complete match, no periodic behavior is detected, and the calculations may continue. Before the calculations continue, the tested coordinate is added to the cache, for further comparisons.

It will require too much memory and processor time to keep all calculated coordinate sets of the system in the cache. Hence, only selected coordinates are stored, as illustrated in FIG. 15.

The cache consists of a number of levels, each containing a coordinate of age growing by level. After each test or after a number of tests, the tested coordinate is inserted at level 0. Every second time (or any other time) a coordinate is inserted into level 0, the old value is inserted into level 1 before it is overwritten. The method for inserting coordinates at the other levels is similar; every second time a value is inserted at any level, the old value is transported to the next level before it is overwritten at the current level.

This method results in a coordinate cache containing coordinates with an exponentially growing age. Level 0 stores coordinates with an age of 1 or 2 (the prior checked coordinate or the one before the prior checked coordinate), level 1 stores coordinates with an age of 3-6 (3 at the test after the coordinate has been inserted, and then growing to 6 before the next coordinate is inserted), level 2 stores coordinates with an age of 7-14, and so on.

The pseudo program code in Example I shows how the cache may be implemented.

Because the age of the levels is varying, a periodic solution may not be found immediately. A periodic solution having a period length of 11 tests will be detected at level 2 of the cache, because the age of the data at level 2 is between 7 and 14. However, the test will not detect the periodic solution before the coordinate is exactly 11 tests old. Therefore up to 12 tests may be performed before the periodic behavior is detected. In this case, it means that the system may pass through up to 12/11 period before it is detected.

A possible expansion to the algorithm described above is a varying TransportAge, cf. the pseudo code program in Example I. If some coordinates can be identified as more likely to take part of a periodic solution then others, the InsertCoordinate procedure, cf. the pseudo code program in Example I, may recognize them, and use a reduced value of TransportAge for those. This will favor the critical coordinates in the cache, and make the data in cache become younger if many critical coordinates are stored. The younger age of data in the cache makes a periodical solution detectable after less iteration within the periodic solution.

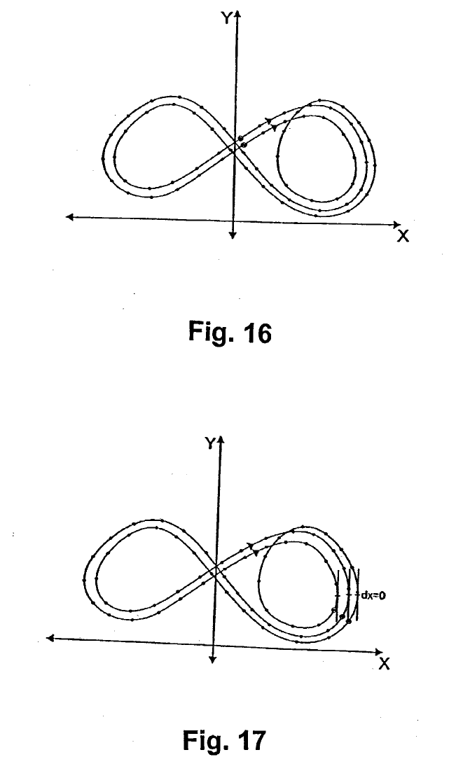

The test may be performed after each iteration. That means every time we have calculated a new coordinate set of the solution. However, to save processor resources, the test should instead be performed at a periodic interval. I order to make the test work; the test must be performed when the solutions is at a recognizable position. One way to make sure the test is performed at the same position each time is to find a recognizable point in the graphical plot of the solution. To do so, the system has to be analyzed for its characteristic behavior, and a criterion has to be chosen. For the above shown non-linear system, the examples of criteria illustrated in FIGS. 16-18 are useable.

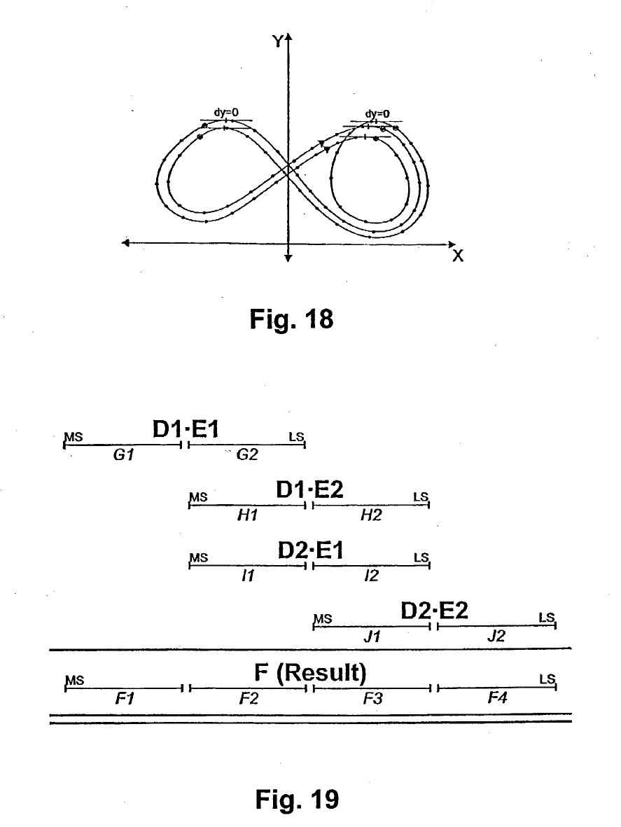

First possible criterion, as illustrated in FIG. 16 is change of sign of x from minus to plus. That is, when the sign of x changes from minus to plus, the test is performed. The second criterion is change of sign of dx from plus to minus, as illustrated in FIG. 17. The third criterion is change of dy from plus to minus, as illustrated in FIG. 18.

When choosing the criterion, two considerations have to be made. First of all, all possible periodic solutions shall be able to fulfil the criterion. Secondly, to reduce processor load, the criterion with fewest tests should be selected.

At design time some extra tests can be performed on the systems and the chosen parameter spaces, to ensure the efficiency, stability and correctness of the system. These tests may include calculations of Lyapunov exponents, using Gram-Schmidt orthogonalization, as well as statistical analysis of the keystream.

### EXAMPLE I

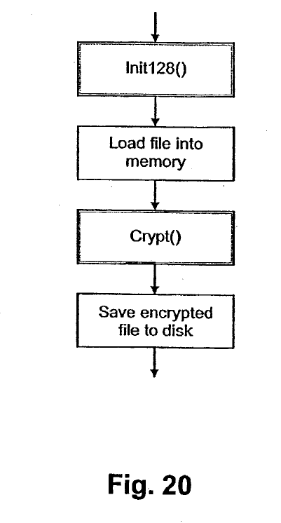

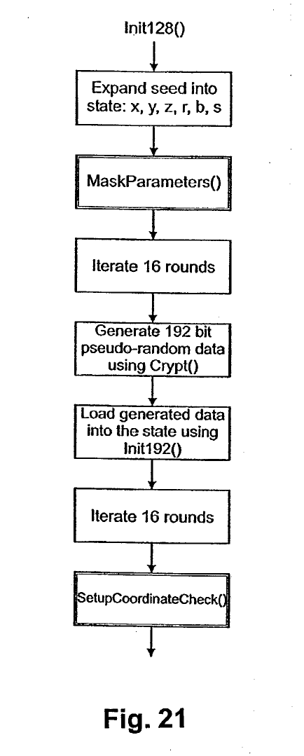

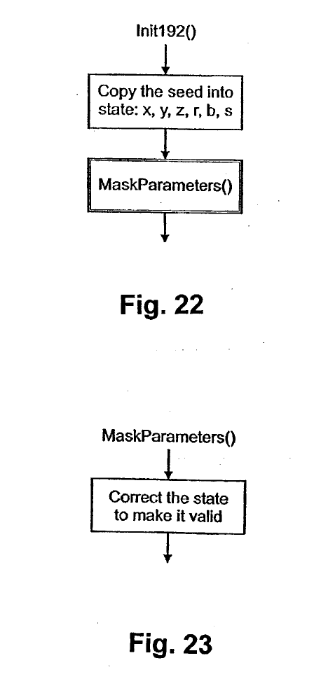

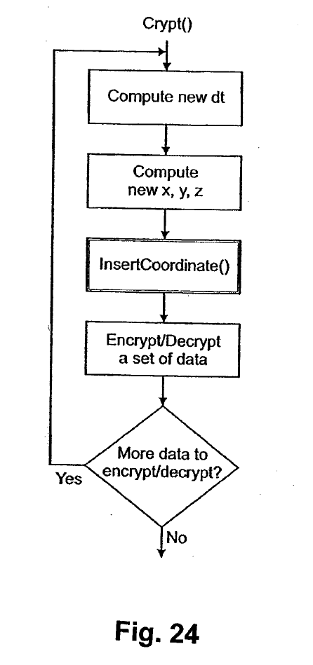

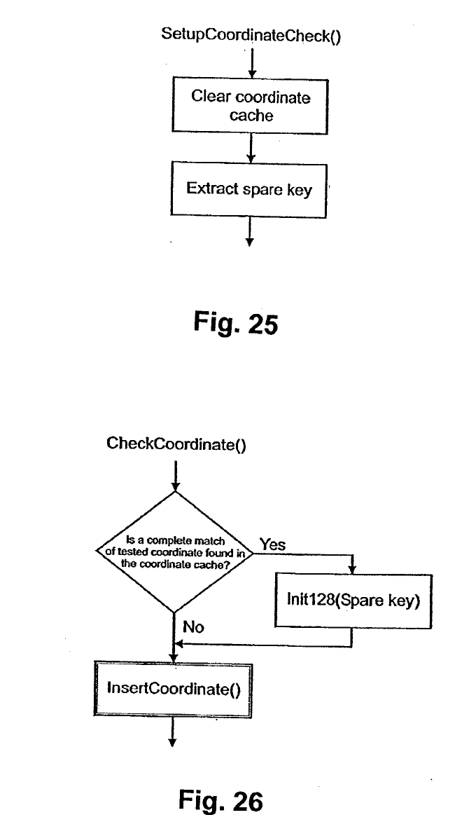

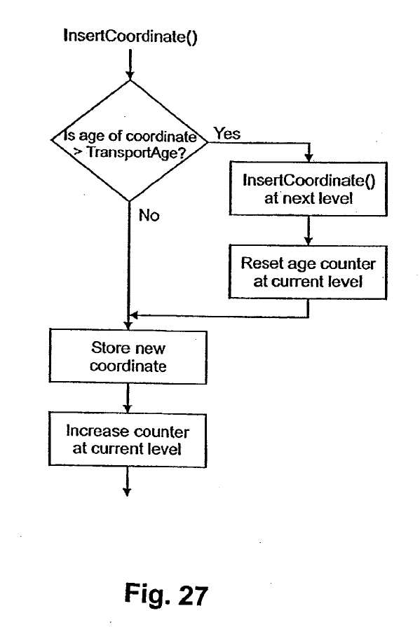

The following pseudo code program shows an example of a program for encrypting and decrypting data which encrypts one byte at a time. The program works in accordance with the flow charts of FIGS. 20-27. The program works with 32-bit registers. FIG. 20 illustrates a method which encrypts a file containing data. FIGS. 21-27 correspond to those functions shown in the pseudo-code below which relate to check for periodic solution and to a stream-cipher using the Lorenz system.

Pseudo-Code for Fixed-Point Library

FloatToFixedPoint: Converts a floating-point number, X, into a fixed-point number. The result of the function has the format S(a.b) or U(a.b)

| fixedpoint FloatToFixedPoint (float X) | |
|---|---|
| { | |
| return X*2^{b}; | // b is the number of bits after the decimal |
| | // separator in the fixed-point |
| | // representation of the result |
| } | |

FixedPointToFloat: Converts a fixed-point number, X, having the format S(a.b) or U(a.b), into a floating-point number.

| float FixedPointToFloat (fixedpoint X) | |
|---|---|
| { | |
| return X*2^{-b}; | // b is the number of bits after the decimal |
| | // separator in the filed-point |
| | // representation of x |
| } | |

ConvertFixedPoint: Converts an Input fixed-point number, X, having the format S(a.b) or U(a.b), into the requested format, S(c.d) or U(c.d). The result is signed if the argument, X, is signed, and vise versa.

| fixedpoint ConvertFixedPoint (fixedpoint X) | |
|---|---|
| { | |
| return X*2^{d-b}; | // b is the number of bits after the decimal |
| | // separator in the fixed-point |
| | // representation of X. d is the number of |
| | // bits after the decimal separator in the |
| | // fixed-point representaiton of the result |
| } | |

Addition and subtraction of fixed-point numbers in the same format are performed using ordinary integer addition and subtraction functions.

MulFixedPoint: Multiply two fixed-point numbers, X and Y. X has the format S(a.b) or U(a.b) and Y has the format S(c.d) or U(c.d). The resulting fixed-point number, has the format S(e.f) or U(e.f). The result as well as X and Y must all be either signed or unsigned values and stored in 32-bit registers. “>>” is the arithmetic shift right for signed multiplication and logical shift right for unsigned multiplication.

fixedpoint MulFixedPoint (fixedpoint X, fixedpoint Y)

| | |
|---|---|
| { | |
| fixedpoint64 Temp; | // A 64-bit register to hold the intermediate |
| | // result |
| Temp = X*Y; | // Two 32-bit values X and Y are multiplied |
| | // into the 64-bit intermediate result |
| return Temp >> b+d−f; | // b and d are the number of bits after the |
| | // decimal separator in the fixed-point |
| | // representation of X and Y respectively. |
| | // f is the number of bits after the decimal |
| | // separator in the fixed-point |
| | // representation of the result. |
| | // The conversion of the value of a 64-bit |
| | // register into a 32-bit register is |
| | // performed by ignoring the 32 most |
| | // significant bits and copying |
| | // the 32 least significant bit into the |
| | // destination register. |
| } | |

Pseudo-Code for Check for Periodic Solution

Global constants in the sub-system for checking for periodic solutions. The code is able to detect periods when the number of inflexions is lesser than TransportAge^{CacheDepth-1} (Note that there can only be half as many inflexions as iterations.)

const int CacheDepth=32;

const int TransportAge=2;

const int SpareSeedLength=16;

The sub-system for checking for periodic solutions has a number of global variables e.g. to store the cache of old coordinates and the spare key to be loaded if a periodic solutions is found.

fixedpoint xCache[CacheDepth];

fixedpoint yCache[CacbeDepth];

fixedpoint zCache[CacheDepth];

int CoordinateAge[CacheDepth];

char SpareSeed[SpareSeedLength];

fixedpoint xOld, xOldOld;

SetupCoordinateChecko: Set up the sub-system for checking for periodic solutions. All positions of the coordinate cache is reset to (x, y, z)=(0, 0, 0), since (0, 0, 0) is a stationary point for the Lorenz system, and therefore is a coordinate value indicating that a reload of the key is needed.

void SetupCoordinateCheck( )

| | |
|---|---|
| { | |
| int i; | |
| | // Clear coordinate cache |

for (i=0; i<CacheDepth; i++)

| | |
|---|---|
| { | |
| xCache[i] = 0; | |
| yCache[i] = 0; | |
| zCache[i] = 0; | |
| CoordinateAge[i] = 1; | |
| } | |
| xOld = 0; | // Variables for detecting when to check are |
| xOldOld = 0; | // reset |
| | // Prepare spare seed |

for (i=0; i<SpareSeedLength ;i++)

| | |
|---|---|
| SpareSeed[i] = 0; | |
| | // Generate the spare key |

Crypt(SpareSeed, SpareSeed+SpareSeedLength−1);
}

InsertCoordinate: Inserts a coordinate at a certain level of the coordinate cache if the age of the previous values stored at that level has passed a certain threshold value. Before the old coordinate at that certain level is overwritten, is it inserted at the next level.

void InsertCoordinate (fixedpoint x, fixedpoint y, fixedpoint z, int Level)

| | |
|---|---|
| { | |
| | // Transfer current coordinate at this level |
| | // (“Level”) to next level (“Level”+1), if |
| | // its age is equal to “TransportAge”, unless |
| | // this level is the highest level possible. |

```
  if ((CoordinateAge[Level] >= TransportAge)
  && (Level+1 < CacheDepth))
  {
    InsertCoordinate(xCache[Level], yCache[Level],
    zCache[Level], Level+1);
    CoordinateAge[Level] = 0;
  }
```

| | |
|---|---|
| xCache[Level] = x; | // Insert the new coordinate |
| yCache[Level] = y; | |
| zCache[Level] = z; | |
| | // Increase the age counter for this level |

CoordinateAge[Level]++;
}

CheckCoordinate: Checks if the x variable solution curve has an inflexion, for which the sign of the slope of the curve changes from positive to negative. If not, the function exits. Otherwise the function checks if an equal coordinate is stored in the coordinate cache. If a match is found, the function loads the spare key into the algorithm. Finally, the coordinate is inserted into the coordinate cache.

void CheckCoordinate (fixedpoint x, fixedpoint y, fixedpoint z)
{
int i;

// If inflexion, where the slope of
// x curve changes from positive to
// negative ...

```
  if ((x <= xOld) && (xOldOld <= xOld))
  {
```

// Check all stored coordinates ...

```
    for (i=0;i<CacheDepth;i++)
    {
```

// If match is found ...

```
      if ((xCache[i] == x) && (yCache[i] == y) && (zCache[i] == z))
      {
```

// Period is found! - Load spare key
// and reinitialize

```
        Init128(SpareSeed);
        break;
      }
    }
```

// Insert the coordinate into the
// coordinate cache

```
    InsertCoordinate(x, y, z, 0);
  }
```

// Store the x value for future comparison

```
  xOldOld = xOld;
  xOld = x;
}
```

Pseudo-Code for Stream-Cipher Using the Lorenz System

In this context, the modulus function, MOD, which takes an argument, q, returns a positive values in the range [0;q[.

The aσvariable in the Lorenz equations has been renamed to “s”.

The format of the fixed-point variables are defined according to Table I.

TABLE I

| Variable | Fixed-point format |
|---|---|
| r | s(7.24) |
| b | s(7.24) |
| s | s(7.24) |
| x | s(7.24) |
| y | s(7.24) |
| z | s(7.24) |

The format of the temporary fixed-point variables used in the Crypt function are defined according to Table II.

TABLE II

| Variable | Fixed-point format |
|---|---|
| tx | s(15.16) |
| ty | s(15.16) |
| tz | s(15.16) |
| dt | s(12.19) |

Allowed values for parameters, r, b, and s, and allowed starting conditions for coordinates, x, y, and z are listed in Table III:

TABLE III

| Variable | Allowed value |
|---|---|
| r | [1; 5[ |
| b | [b + 10; b + 18[ |
| s | [4 · b + 0.5 · s + 12.5; 4 · b + 0.5 · s + 20.5[ |
| x₀ | [−32; 32[ |
| y₀ | [−32; 32[ |
| z₀ | [−32; 32[ |

Crypt: Encryption, decryption and PRNG function. Arguments are PData (pointer to the first byte to encrypt/decrypt) and PEnd (pointer to the last byte to encrypt/decrypt). If the function is intended to generate pseudo-random numbers, the function should be given an amount of data to encrypt (e.g. zeroes) of the same size as the requested pseudo-random data.

void Crypt(char* PData, char* PEnd)

```
{
  fixedpoint dt;
  while (Pdata <= PEnd)
  {
```

| | // Calculation of the time step |
|---|---|
| dt = 10*2⁻¹¹ + x MOD 2⁻¹¹; | |
| tx = s*(y−x); | // Calculation of the next state |
| ty = x*(r−z)−y; | |
| tz = x*y−b*z; | |
| x = x + tx*dt; | |
| y = y + ty*dt; | |
| z = z + tz*dt; | |
| | // Check and insert the coordinate |
| InsertCoordinate(x, y, z, 0); | |
| | // Extract and encrypt |
| *PData = *PData XOR ((y*2²⁴ XOR y*2¹⁶) MOD 2⁸); | |
| PData = PData + 1; | // Increase the pointer to data to encrypt |

}
}

MaskParameters: To ensure that the initial state and the parameters are valid after loading an expanded key or a pseudo-random sequence, the state and parameters has to be modified using this function. The correction is performed according to the restrictions defined in table III.

void MaskParameters( )

{

x = x*0.25;
y = y*0.25;
z = z*0.25;
b = (b MOD 4) + 1;
s = (s MOD 8) + 10 + b;
r = (r MOD 8) + 12.5 + 2*b + 0.5*s;

}

Init192: Load a 192-bit seed (pointed to by the PSeed pointer) into the state of the system.

void Init192(char* PSeed)
{

| | |
|---|---|
| x = *PSeed; | // Copy the seed into the state |
| y = *(PSeed+4); | |
| z = *(PSeed+8); | |
| r = *(PSeed+12); | |
| b = *(PSeed+16); | |
| s = *(PSeed+20); | |
| MaskParameters( ); | // Correct the state to make it valid |

}

Init128: Load a 128-bit seed (or key) (pointed to by the PSeed pointer) into the state of the system performing the key setup procedure.

void Init128(char* PSeed)

| | |
|---|---|
| { | |
| char Seed192[24]; | // Allocate 24 bytes of memory |
| int i; | |
| x = *PSeed; | // The seed is expanded into the state |
| y = *(PSeed+3); | |
| z = *(PSeed+6); | |
| r = *(PSeed+8); | |
| b = *(PSeed+10); | |
| s = *(PSeed+12); | |
| MaskParameters( ); | // Make state valid |
| | // Iterate 16 rounds before extraction |

Crypt(Seed192, Seed192+15);

| | |
|---|---|
| for (i=0;i<24;i++) | // Reset the data in Seed to zeroes |
| Seed192[i] = 0; | |
| | // Generate 24 bytes of pseudo-random data |

Crypt(Seed192, Seed192+23);

| | |
|---|---|
| Init192(Seed192); | // Load the pseudo-random data into the state |
| | // Iterate 16 rounds before using the |
| | // algorithm |

Crypt(Seed192, Seed192+15);

// Initiate the coordinate check algorithm

SetupCoordinateCheck( );
}

The statistical properties of the output of the system, i.e. the keystream, may be tested according to the NIST (National Institute of Standards and Technology) Test Suite, cf. ‘A statistical test suite for random and pseudo-random number generators for cryptographic applications’, NIST Special Publication 800-22. See also http://csrc.nist.gov/rng/rng2.htmi. The NIST Test Suite comprises sixteen different tests, which are briefly summarized below. The tests may for example be performed on a program similar to the above pseudo-code for a stream cipher using the Lorenz system.

The tests deliver a number of almost non-overlapping definitions of randomness. The simpler definitions are included below, whereas those definitions which require more complicated concepts from the theory of probability are referred to by the phrase “what can be calculated/is expected for a truly random sequence”. The above NIST publications contain the appropriate definitions and references to works on the theory of probability.

Frequency monobit test: This test determines the proportion of zeroes and ones for the entire keystream sequence. For a truly random keystream sequence, the number of ones is expected to be about the same as the number of zeros. During the test, it is investigated whether this property holds for the keystream sequence in question.

Frequency block test: In this test, the keystream sequence is divided into M-bit blocks. In a truly random keystream sequence, the number of ones in each block is approximately M/2. If this also characterizes the tested keystream sequence, the test is regarded as successful.

Runs test: A run within the keystream sequence is defined as a sub-sequence of identical bits. The test checks for runs of different lengths, where a run of length k is constituted by k identical bits bounded by bits of a value opposite to the bits in the run. The occurrence of runs of different lengths is compared to what is expected for a truly random sequence.

Longest run of zeroes: In this test, the sequence is divided into blocks of M bits each, and the longest run of ones within each block is found. The distribution of the lengths of runs for the blocks is compared to the distribution for blocks in a random sequence. An irregularity in the expected length of the longest run of ones indicates that there is also an irregularity in the expected length of the longest run of zeroes.

Binary matrix rank test: In this test, fixed length sub-sequences of the keystream sequence are used to form a number of matrices by colllecting M-Q bit seggments into M by Q matrices. By calculating the rank of these matrices, the test checks for linear dependence among the sub-sequences.

Discrete Fourier transform test: By applying the discrete Fourier transform, this test checks for periodic characteristics of the keystream sequence. The height of the resulting frequency components are compared to a threshold defined from a truly random sequence.

Non-overlapping template matching test: When performing this test, a number of non-periodic m-bit patterns are defined, and the occurrences of the particular patterns are counted.

Overlapping template matching test: This test is very similar to the non-overlapping template matching test, the only differences being the structure of the pattern of m bits, and the way the search for the pattern is performed. The pattern of m bits is now a sequence of m ones.

Maurer's universal statistical test: This test calculates the distance between matching patterns in the keystream sequence. By doing so, a measure of the compressibility of the keystream sequence is obtained. A significantly compressible keystream sequence is considered to be non-random.

Lempel-Zlv compression test: In this test, the number of cumulatively distinct patterns is calculated, thus providing a measure of the compressibility of the keystream sequence. The result is compared to a random sequence, which has a characteristic number of distinct patterns.

Linear complexity test: This test calculates the length of a linear feedback shift register in order to determine whether or not the sequence is complex enough to be considered random.

Serial test: This test calculates the frequency of all possible overlapping m-bit patterns across the entire sequence. For a truly random keystream sequence, all of the 2^{m} possible m-bit patterns occur with the same probability. The deviation from this probability is calculated for the keystream sequence in question.

Approximate entropy test: This test has the same focus as the serial test, but with the added feature that the frequencies of m- and (m+1)-bit patterns are calculated. The results obtained for the patterns of different length are compared and used to characterize the sequence as either random or non-random.

Cumulative sums test: In this test, the sequence is used to define a random walk with ones and zeroes corresponding to +1 and −1, respectively. It is determined whether the amplitudes of the cumulative sums of the partial keystream sequences are too large or too small relative to what is expected for a truly random keystream sequence.

Random excursions test: In this test, the sequence is similarly to the cumulative sums test transferred into a random walk. The number of visits to certain states (values the cumulative sum can hold), which the random walk potentially passes through, is used to characterize the sequence as either random or non-random. The considered states are −4, −3, −2, −1, 1, 2, 3, 4.

Random excursions variant test: Almost identical to the random excursions test. Eighteen states are used in this test.

For each test, a P-value, Pᵥₐₗ, is calculated, which provides a quantitative comparison of the actual sequence and an assumed truly random sequence. The definitions of the P-values depend on the actual test (see the NIST documentation). Values of Pᵥₐₗ>α Indicate randomness, where α is a value in the interval 0.001≦α≦0.01, the exact value of α being defined for each test. Otherwise, non-randomness is declared.

The NIST Test Suite defines, for each test, the proportion of samples, whose P-value should pass the criterion Pᵥₐₗ>α. In all of the above tests, except the Random excursions test, the proportion of samples whose respective P-values, Pᵥₐₗ, pass the appropriate criteria should be at least 0.972766. For the Random excursions test, the proportion given by NIST is at least 0.967813.

In preferred embodiments of the method, the following proportions are preferably achieved, as an average of at least 10⁴ samples obtained by use of randomly chosen keys: at least 0.975, such as at least 0.98, such as at least 0.985, such as at least 0.99, such as at least 0.995, such as at least 0.998.

Possible input parameters to the NIST Test Suite are given in Table IV below in the notation used in the documentation accompanying the NIST Test Suite.

TABLE IV

| Name of test | Input |
|---|---|
| Frequency block test | m = 100 |
| Longest run test | M = 10000 |
| Non-overlapping templates matching test | m = 9 |
| Overlapping templates matching test | m = 9 |
| Maurer's universal test | L =7, Q =1280 |
| Serial test | m = 5 |
| Approximate entropy test | m = 5 |

### EXAMPLE II

Table V shows the speed of encryption provided by a method as generally disclosed herein, cf. FIGS. 1-5, as well as speeds of encryption of various known encryption methods. The speed of encryption provided by the methods of the present invention was measured in respect of an algorithm as described in M. Boesgaard, M. Vesterager, T. Pedersen, J. Christiansen and O. Scavenius: Rabbit: A New High-Performance Stream Cipher, Proceedings of Fast Software Encryption (FSE) 2003, Springer, Berlin, (2003). The algorithm was Implemented in assembly language using MMX™ Instructions.

From the measurements, the speed was calculated to be equivalent to an encryption/decryption speed of 947 Mbit/sec on a 450 MHz Pentium III processor.

TABLE V

| | | | | | | | Memory |
|---|---|---|---|---|---|---|---|
| | Year of | | | | Speed | | Requirements |
| | intro- | | Key size | Block | [clocks/ | Speed | for tables etc. |
| Name | duction | Type | [bit] | size [bit] | byte] | [Mbit/s] | [bytes] |
| AES/Rijndael | 1998 | block | 128-256 | 128-256 | 14.8³ | 243 | >256-4096 |
| Blowfish | 1994 | block | 32-448 | 64 | 18² | 200 | <5K |
| Present | | stream | 128 | — | 3.7 | 947 | 60 |
| Method | | | | | | | |
| DES | 1975 | block | 56 | 64 | 45² | 80 | >256 |
| IDEA | 1992 | block | 128 | 64 | 50² | 72 | >12 |
| Panama | 1998 | stream | 256 | — | 6.7¹ | 537 | >1092 |
| RC4 | 1987 | stream | 32-2048 | — | 7² | 514 | >256 |
| SNOW | 2000 | stream | 128-256 | — | 6.5⁴ | 554 | 1024 |
| SOBER-t32 | 2000 | stream | 128 | — | 21⁴ | 171 | ? |

Speed is estimated from different sources. The superscripts in the “Speed [clocks/byte]” column of Table V refers to the below source references:
¹Crypto++ 4.0 Benchmarks, www.eskimo.com/˜weidai/benchmarks.html, MS C++ (Intel Celeron 850MHz), available on 6 Jun. 2003.
²Bruce Schneier et al.: Fast Software Encryption: Designing Encryption Algorithms for Optimal Software Speed on the Intel Pentium Processor.
³Kazumaro Aoki et al.: Fast Implementation of AES Candidates (128 bit keys, 128 bit blocks, Pentium II).
⁴Performance of Optimized Implementations of the NESSIE Primitives (version 2.0), http://www.cosic.esat.kuleuven.ac.be/nessie/ available on 6 Jun. 2003 (Pentium III numbers are used).

In general, speed and memory can be traded for many of the implementations, e.g. by using lookup tables which require more memory but may save processing time.

END OF EXAMPLE II

When performing computations on numbers expressed as binary numbers, for example when adding or multiplying two numbers, it may be possible to omit parts of the computations involved in addition or multiplication, if bits of a number resulting from the addition or multiplication may be omitted or disregarded. Thus, if the least significant bits of the resulting number are not necessary or if the most significant bits of the resulting number may be disregarded (which may be the case in a pseudo-random number generator, where what is needed is not the true result of the computations but merely a pseudo-random number), the least and/or most significant bits of the resulting number need not be computed.

Thus, a method for performing mathematical operations on integer numbers of a certain bit width which is larger than the register width of the processing unit on which the computations are performed is disclosed. Mathematical operations or computations on fixed-point numbers are performed as integer operations, whereby the integer numbers are expressed as binary numbers. The binary representation of integer numbers requires a certain register width, e.g. 32 bit. When performing mathematical operations, such as addition or multiplication, by means of a processing unit having a register width which is smaller than the width required for representation of the binary numbers, e.g. 8 bit, the binary numbers may be split into a plurality of binary sub-numbers, each represented by a width equal to or smaller than the register width of the processing unit. Thus, two 32 bit numbers may be split into two sets of four 8 bit sub-numbers, and multiplication or addition may be performed on the 8 bit sub-numbers by means of an 8 bit processing unit. For example, addition of a number

A=11011001101101010110101010110111 and a number

B=10000111011110111111010101001001

to achieve a result R=A+B may be performed by performing the following steps:

1. Each of the numbers A and B is split into four sub-numbers, A1, A2, A3, A4, and B1, B2, B3, and B4. A1 represents the 8 most significant bits of the number A, and A4 represents the 8 least significant bits of the number A, etc. Thus, in the example shown above, the sub-numbers are:

A1=11011001

A2=10110101

A3=01101010

A4=10110111

B1=10000111

B2=01111011

B3=11110101

B4=01001001

2. The least significant sub-numbers, A4 and B4 are then added: R4=A4+B4. Any carry resulting from the addition of A4 and B4, C4, is stored.

3. The second least significant sub-numbers, A3 and B3, and the carry from step 2 above, C4, are then added: R3=A3+B3+C4. Any carry resulting from this addition, C3, is stored.

4. Addition of A2 and B2 in a way analogous to step 3, to achieve R2 and C2.

5. Addition of A1 and B1 in a way analogous to steps 3 and 4 to achieve R1. Any carry resulting from this addition, C1, is regarded as overflow and is not taken into consideration.

6. The number resulting from the addition of A and B is stored as four sub-numbers, R1, R2, R3 and R4, and/or represented by a 32 bit wide string built from the sub-numbers R1, R2, R3, and R4.

In case not all bits in a number resulting from a multiplication operation are to be used in further computations, and/or in case not all bits are significant for the further computations and may be disregarded, processing time in connection with multiplication operations on a processing unit having a register width smaller than the bit width of the numbers to be multiplied may be reduced by performing only partial multiplication as explained below. For example, multiplication of two 16 bit numbers, D and E, wherein

D=1101100110110101 and

E=0110101010110111

on an 8 bit processing unit to achieve a 32 bit number, F, may be performed by the following steps:

1. Each of the numbers D and E are split into two sub-numbers, D1, D2, and E1, E2. D1represents the 8 most significant bits of D, D2 represents the 8 least significant bits of D, etc. Thus, in the example shown above, the sub-numbers are:

D1=11011001

D2=10110101

E1=01101010

E2=10110111

2. D1 is multiplied with E1 to achieve a 16 bit number expressed as two 8 bit numbers, G1 and G2.

3. D1 is multiplied with E2 to achieve a 16 bit number expressed as two 8 bit numbers, H1 and H2.

4. D2 is multiplied with E1 to achieve a 16 bit number expressed as two 8 bit numbers, I1 and I2.

5. D2 is multiplied with E2 to achieve a 16 bit number expressed as two 8 bit numbers, J1 and J2.

6. The resulting 32 bit number F is expressed as four 8 bit numbers, F1, F2, F3, and F4, wherein:

F4=12

F3=H2+I2+J1

F2=G2+H1+I1+[any carry resulting from the calculation of F3]

F1=G1+[any carry resulting from the calculation of F2],

as illustrated in FIG. 19 wherein MS denotes “most significant 8 bit” and LS denotes “least significant 8 bit”.

Processing time may be saved by disregarding F4, i.e. the least significant bits of the number resulting from the multiplication, and by disregarding J1 in the addition which leads to F3. Thus, the multiplication of D2 with E2 at step 5 may be omitted, whereby less mathematical operations are performed, which leads to saving of processing time. This omission has an impact on the computational result which, however, may be acceptable if the omission is performed consistently throughout the computations in, e.g. a pseudo-random number generator, e.g. in an encryption/decryption algorithm, and if it is performed both in decryption and encryption. It should usually be ensured that properties of the mathematical system, e.g. chaotic behavior, which are of importance in the context in question, e.g. encryption/decryption, are maintained in spite of the impact which the omission of one or more computational steps has on the computations.

There is further provided a method of performing multiplication operations on a first binary number and a second binary number. The method comprises summing a number of intermediate results, whereby the sum of the intermediate results is equal to the product of the two numbers. Each intermediate result is achieved as the product of one single bit (1 or 0) of the first number and the entire second number, α, whereby the product and thus the intermediate number may be determined by a simple “if . . . then” algorithm and/or a logical AND operation, as the product of 1·α=α, and as the product of 0·α=0.

Subsequent to computing the intermediate number, the intermediate number is shifted a number of positions to the left, the number of positions corresponding to the position of the bit of the first number from which that particular intermediate number is calculated. Alternatively, either the second number or the particular bit of the first number is switched to the left. Accordingly, the step of multiplying one bit of a first one of the two numbers is repeated for each bit of the first number. For example the product of a first number, 0110, and a second number 1010 is computed as follows: the least significant bit of the first number, 0, is multiplied with the second number 1010 to obtain a first intermediate number, 0000. Then, the second least significant bit of the first number, 1, is multiplied with the second number and shifted one position to the left to obtain a second intermediate number, 10100. Then, the third least significant bit of the first number, 1, is multiplied with the second number and shifted two positions to the left to obtain a third intermediate number, 101000. Finally, the most significant bit of the first number, 0, is multiplied with the second number and shifted three positions to the left to obtain a fourth intermediate number, 0000000. The resulting number is obtained as a sum of the four intermediate numbers, as illustrated below, the underlinings indicating which bits are being multiplied in the individual steps:

0110·1010→0000 (first intermediate number)

0110·1010→10100 (second intermediate number)

0110·1010→101000 (third intermediate number)

0110·1010→0000000 (fourth intermediate number)

Result: 0111100 (sum of intermediate numbers)

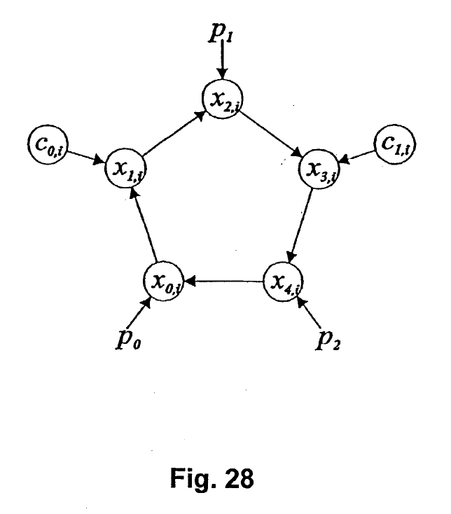

FIG. 28 illustrates a further mathematical system which may be employed in the methods of the present invention. A set of five coupled subsystems is provided, wherein the subsystems are one-dimensional maps. Three of the maps contain static parameters and two of the maps are influenced by a counter. The system configuration is illustrated in FIG. 28.

The iteration scheme of the system is defined by the following equations:

x_{0,i+1}=((x_{0,i}+p₀)mod1)²+2x_{0,i}+kx_{4,i}mod1

x_{1,i+1}=((x_{1,i}+c_{0,i})mod1)²+2x_{1,i}+kx_{0,i}mod1

x_{2,i+1}=((x_{2,i}+p₁)mod1)²+2x_{2,i}+kx_{1,i}mod1

x_{3,i+1}=((x_{3,i}+x_{1,i})mod1)²+2x_{3,i}+kx_{2,i}mod1

x_{4,i+1}=((x_{4,i}+p₂)mod1)²+2x_{4,i}+kx_{3,i}mod1

where x_{n,i} is the state variable of system n at iteration i, p₀,p₁ and p₂ are static parameters, c_{0,i} and c_{1,i} are counters. The coupling is unidirectional with coupling strength k. Values in the interval [0;1[ may be assigned to the parameters p₀,p₁ and p₂. The counters c_{0,i} and c_{1,i}, cycle through the interval [0;1[ by increments which are a fraction of 1. The increments of c_{0,i} and c_{1,i} need not be identical. The counters may be incremented independently of each other. In another embodiment, a first one of the counters is only incremented when a second one of the counters reaches a certain value. A first one of the counters may be incremented in each iteration, whereas a second one of the counters may be incremented only when the first one reaches its maximum. Alternatively, both counters may be incremented in each iteration, or they may be incremented in an alternating way, so that the first counter is incremented in every second iteration and the second counter is incremented in those iterations where the first counter is not incremented.

1. A method for repeatedly performing computations in a mathematical system which exhibits a positive Lyapunov exponent, comprising varying at least one parameter of the mathematical system after a certain number of computations.

2. A method according to claim 1, wherein at least one variable of the mathematical system is expressed as a fixed-point number.

3. A method according to claim 2, further comprising the steps of:
expressing the mathematical system in discrete terms,
performing said computations in such a way that the computations include the at least one variable expressed as a fixed-point number,
obtaining, from said computations, a resulting number, the resulting number representing at least one of:
a. at least a part of a solution to the mathematical system, and
b. a number usable in further computations involved in the numerical solution of the mathematical system.

4. A method according to claim 1, wherein the mathematical system comprises at least one non-linear map.

5. A method according to claim 1, wherein said at least one parameter is repeatedly varied at predetermined intervals in said computations.

6. A method according to claim 1, wherein said computations involve performing iterations in the mathematical system.

7. A method according to claim 1, wherein said at least one parameter is represented by a counter which varies independently of the mathematical system.

8. A method according to claim 7, wherein the counter is increased at each iteration in the mathematical system.

9. A method according to claim 7, wherein a maximum value is defined for the counter, the method comprising resetting the counter to a minimum value once the counter has reached said maximum value, whereby the counter varies with a certain period.

10. A method according to claim 7, wherein a set of counters is employed, the set comprising multiple counters.

11. A method according to claim 10, wherein the variation of a first one of said counters is dependent from the variation of a second one of said counters in such a way that the period of the first counter is different from the period of the second counter.

12. A method according to claim 10, wherein the variation of each individual one of said counters is dependent from the variation of at least another one of said counters so as to obtain a period of the counters which is longer than the period which would have existed if each individual counter would not have been dependent from the variation of another counter.

13. A method according to claim 1, wherein the one or more counters is/are increased linearly.

14. A method for generating pseudo-random numbers comprising performing mathematical operations by a method according to claim 1.

15. A method for generating an identification value comprising performing mathematical operations by a method according to claim 1.

16. A method for encrypting and/or decrypting data comprising performing mathematical operations by a method according to claim 1.

17. A method according to claim 15, wherein encrypting and/or decrypting comprises generating pseudo-random numbers by a method according to claim 14.

18. A method for manipulating a first set of data in a cryptographic system, the first set of data comprising a first and a second number of a first and a second bit size A and B, respectively, the method comprising:
multiplying the first and the second number to obtain a third number of a third bit size A+B, the third number consisting of P most significant and Q least significant bits, wherein A+B=P+Q, and wherein Q is equal to the largest of the first bit size A and the second bit size B, Q=max(A,B),
manipulating the third number to obtain a fourth number which is a function of at least one of the P most significant bits of the third number,
using the fourth number for deriving an output of the cryptographic system.

19. A method according to claim 18, wherein the first number is equal to the second number.

20. A method according to claim 18, wherein at least one of the first and second number represents at least one state variable of a mathematical system, and wherein the state variable is updated as a function of the fourth number.

21. A method according to claim 20, wherein the state variable is updated as a function of a permutation of the fourth number.

22. A method according to claim 21, wherein the permutation comprises a bitwise rotation of the bits of the fourth number.

23. A method according to claim 18, wherein:
the step of multiplying is performed multiple times, each multiplication being performed on a number which represents or is a function of one of a plurality of state variables, the step of multiplying thereby resulting in a plurality of third numbers, and wherein
the step of manipulating results in an array comprising a plurality of fourth numbers, and wherein
at least one state variable is updated as a function of at least two of the fourth numbers.

24. A method according to claim 18, wherein at least one of the first and second number is a state value Xᵢ to which there is added a variable parameter value.

25. A method according to claim 24, wherein the parameter value is a counter Cᵢ.

26. A method according to claim 25, wherein the step of multiplying comprises squaring (Xᵢ+Cᵢ), wherein Xᵢ denotes a state variable or an array of state variables, and wherein Cᵢ denotes the counter or an array of counters.

27. A method according to claim 24, wherein said at least one parameter is repeatedly varied at predetermined intervals in said computations.

28. A method acccording to claim 18, wherein a counter Cᵢ is added to the fourth number or to a number which is a function of the fourth number to result in an updated state variable Xᵢ₊₁.

29. A method according to claim 18, wherein the step of multiplying comprises calculating x^{k}, x denoting the first number, k denoting an exponent.

30. A method according to claim 29, wherein k is an integer number.

31. A method according to claim 18, wherein the step of manipulating comprises at least one logical operation which is performed on a bit of the most significant bits and a bit of the least significant bits of the third number.

32. A method according to claim 31, wherein the logical operation comprises at least one XOR operation.

33. A method according to claim 32, wherein P=Q, and wherein the at least one XOR operation comprises P XOR operations to result in a result of bit size P, each XOR operation being performed on one bit of the most significant bits of the third number and one bit of the least significant bits of the third number.

34. A method according to claim 18, wherein the step of manipulating comprises at least one arithmetic operation which is performed on at least one bit of the most significant bits and at least one bit of the least significant bits.

35. A method according to claim 18, wherein the step of multiplying comprises a plurality of multiplication functions resulting in a plurality of numbers of bit size A+B, and wherein the step of manipulating comprises combining at least one of the bits of a first one of the plurality of numbers with at least one of the bits of a second one of the plurality of numbers.

36. A method according to claim 35, wherein the plurality of multiplication functions comprises at least one squaring operation, and wherein the step of manipulating comprises combining at least one of the P most significant bits of a first one of the plurality of numbers with at least one of the Q least significant bits of a second one of the plurality of numbers.

37. A method according to claim 18, wherein the step of multiplying is performed in a mathematical system in which at least one state variable is being iterated.

38. A method according to claim 18, wherein the step of multiplying is performed in an iterative system of at least two state variables.

39. A method according to claim 38, wherein, in each computational sequence, values assigned to each of the at least two state variables is updated as a function of at least one value of the same and/or another state variable.

40. A method according to claim 18, wherein the fourth number is used for generating or updating a pseudo-random number as the output of the cryptographic system.

41. A method according to claim 18, wherein at least one of the first and second number is derived from a second set of data to be encrypted or decrypted, and wherein the fourth number is used to generate an encrypted or decrypted representation of the second set of data.

42. A method according to claim 18, wherein at least one of the first and second number is derived from a second set of data, and wherein the fourth number is used for generating an identification value identifying the second set of data.

43. A method according to claim 18, wherein at least one of the first and second number is derived from a cryptographic key.

44. A method for manipulating a first set of data in a cryptographic system, the first set of data comprising a first and a second number, the method comprising:
dividing the first number by the second number to obtain a quotient and a remainder,
combining, by means of a mathematical operation, the quotient and the remainder to obtain a resulting number,
using the resulting number for deriving an output of the cryptographic system.

45. A method for generating a periodic sequence of numbers in a cryptographic system in which computational steps are repeatedly performed, the method comprising updating, in each computational step i, an array of counters, the counters being updated by a logical and/or by an arithmetic function, whereby, at each computational step, a carry value is added to each counter in the array, wherein the carry added to the first counter in the array, c₀, is obtained from at least one of:
a selected computation of a value of the array of counters,
a value which is a function of a counter value at a previous computational step.

46. A method for generating a periodic sequence of numbers in a cryptographic system in which computational steps are repeatedly performed, the method comprising updating, in each computational step i, an array Cᵢ of counters c_{j,i}, the counters being updated as:
c_{0,i+1}=c_{0,i}+a₀+dᵢmodN₀,
c_{j,i+1}=c_{j,i}+aⱼ+b_{j-1,i+1}modNⱼ for j>0,
where:
c_{j,i+1} is a value assigned to position j of array C at step i+1, j=0 . . . n−1, n denoting a dimension of the array C,
c_{j,i} is a value assigned to position j of array C at step i, j=0 . . . n−1,
aⱼ is a value assigned to position j of an array A, j=0 . . . n−1,
for j>0: b_{j-1,i+1} is a carry value resulting from the computation of c_{j-1,i+1,}
Nⱼ is a constant, j=0 . . . n−1,
for i=0: dᵢ=d₀ is an initial value,
for i>0 dᵢ is a carry value obtained from a selected computation of a value of the array of counters Cᵢ and/or a function of Cᵢ.

47. A method according to claim 46, wherein each value a/j is a constant.

48. A method according to claim 46, wherein n=1, so that:
the array C contains a single value c_{0,i},
the array A contains a single value a₀.

49. A method according to claim 46, wherein, for i>0, dᵢ is a carry value resulting from the computation of c_{j-1,i}.

50. A method according to claim 46, wherein dᵢ is a carry value resulting from the computation of c_{j-1,i+1}.

51. A method according to claim 46, wherein the computational steps which are performed in the cryptographic system comprise an iterative procedure in which an array of state variables, X, is repeatedly iterated so that at least one value assigned to a position in the array of state variable X at computational step i+1 is a function of:
at least one value assigned to a position in the array of state variables X at computational step i, and
at least one value assigned to a position of the array of counters C at computational step i.

52. A method according to claim 51, wherein the array of state variables X contains a single variable.

53. A method according to claim 51, wherein the array of state variables X at computational step i+1 is a function of Xᵢ+Cᵢ, Xᵢ₊₁=f(Xᵢ+Cᵢ).

54. A method according to claim 46, wherein the product of N₀·N₁· . . . ·Nₙ₋₁−1 and a concatenated value of A are mutually prime.

55. A method for generating an output of a cryptographic system in which computational steps are performed as an iterative procedure wherein an array of state variables, X, is repeatedly iterated so that at least one value assigned to a position in the array of state variables X at iteration step i+1 is a function of:
at least one value assigned to a position in the array of state variables X at iteration i, and
at least one value assigned to a position of an array of counters C at iteration i,
the array of counters being updated in each iteration as:
c_{0,i+1}=c_{0,i}+a₀+dᵢmodN₀,
c_{j,i+1}=c_{j,i}+aⱼ+b_{j-1,i+1}modNⱼ for j>0,
where:
c_{j,i+1} is a value assigned to position j of array C at step i+1, j=0 . . . n−1, n denoting a dimension of the array C,
c_{j,i} is a value assigned to position j of array C at step i, j=0 . . . n−1,
aⱼ is a value assigned to position j of an array A, j=0 . . . n−1,
for j>0: b_{j-1,i+1} is a carry value resulting from the computation of c_{j-1,i+1,}
Nⱼ is a constant, j=0 . . . n−1,
for i=0: dᵢ=d₀ is an initial value,
for i>0 dᵢ is a carry value obtained from a selected computation of a value of the array of counters Cᵢ and/or a function of Cᵢ,
each iteration comprising:
multiplying a first number of a first bit size A and a second number of a second bit size B to obtain a third number of a third bit size A+B, at least one of the first and second number being equal to or a function of at least one value assigned to a position of the array of state variables X at iteration i, the third number consisting of P most significant and Q least significant bits, wherein A+B=P+Q, and wherein Q is equal to the largest of the first bit size A and the second bit size B, Q=max(A,B),
manipulating the third number to obtain a fourth number which is a function of at least one of the P most significant bits of the third number,
using the fourth number for deriving the output of the cryptographic system and/or for assigning new values to positions of the array of state variables X.

56. A method of determining an identification value for identifying a set of data and for concurrently encrypting and/or decrypting the set of data, the method comprising performing numerical computations in a mathematical system exhibiting a positive Lyapunov exponent.

57. A method according to claim 56, further comprising the steps of:
expressing the mathematical system in discrete terms,
expressing at least one variable of the mathematical system as a fixed-point number,
performing said computations in such a way that the computations include the at least one variable expressed as a fixed-point number,
obtaining, from said computations, a resulting number, the resulting number representing at least one of:
a. at least a part of a solution to the mathematical system, and
b. a number usable in further computations involved in the numerical solution of the mathematical system.

58. A method according to claim 56, the method further comprising repeatedly performing mathematical computations as iterations in the mathematical system, whereby various parts of the set of data or modifications thereof may be used as input to the computations.

59. A method according to claim 56, the method further comprising:
repeatedly performing mathematical computations as iterations in the mathematical system, whereby various parts of the set of data or modifications thereof may be used as input to the computations, following each computation or a certain number of computations:
extracting a resulting number from the computations, the resulting number representing at least one of:
a. at least a part of a solution to the mathematical system, and
b. a number usable in further computations involved in the numerical solution of the mathematical system,
determining an updated value for the identification value based on the resulting number, whereby various parts of the set of data or modifications thereof may be used as input in the step of determining,
encrypting and/or decrypting a certain portion of the set of data based on the resulting number,
whereby as many iterations are performed as required for encrypting and/or decrypting the entire set of data.

60. A method according to claim 56, further comprising:
expressing the mathematical system in discrete terms,
expressing at least one variable of the mathematical system as a fixed-point number,
performing said computations in such a way that the computations include the at least one variable expressed as a fixed-point number.

61. A method according to claim 56, wherein the identification value is further modified following encryption and/or decryption of the entire set of data.
